(19) United States
(12) Patent Application Publication
(10) Pub. No.: US 2021/0374799 A1
(43) Pub. Date: Dec. 2, 2021

(54) ITERATIVE PROCESS FOR INTELLIGENTLY MODELING A DIVERSE PORTFOLIO OF AVAILABLE CONTENT

(71) Applicant: Groupon, Inc., Chicago, IL (US)

(72) Inventors: Prashant GAURAV, Mountain View, CA (US); Rajesh PAREKH, San Jose, CA (US); Michalis POTAMIAS, San Francisco, CA (US)

(21) Appl. No.: 17/181,061

(22) Filed: Feb. 22, 2021

Related U.S. Application Data
(63) Continuation of application No. 13/803,275, filed on Mar. 14, 2013, now abandoned.
(60) Provisional application No. 61/709,623, filed on Oct. 4, 2012.

(51) Int. Cl. G06Q 30/02

(52) U.S. Cl. CPC G06Q 30/0249

(57) ABSTRACT

Various methods are provided for intelligently modeling a diverse promotion portfolio. One example method may comprise utilizing an analytical model to intelligently generate a proposed promotion portfolio of available promotions by performing an iterative process in which a determination is made as to whether the proposed promotion portfolio that is generated projects a predicted revenue that at least meets the target revenue over the predefined period of time for the geographic area, in an instance in which the determined proposed promotion portfolio value fails to meet the target revenue over the predefined period of time for the geographic area, repeating the iterative process and altering the weighting values, in an instance in which the determined proposed promotion portfolio value at least meets the target revenue over the predefined period of time for the geographic area, ending iterative process, and generating the inventory of promotions in accordance with the proposed promotion portfolio.

### TECHNOLOGICAL FIELD

The present description relates to offering content associated with a product or a service. This description more specifically relates to a promotion offering system determining a mix of promotions to offer across a plurality of promotion categories.

### BACKGROUND

Merchants typically offer promotions to consumers from time to time in order to generate more business. The promotions offered may be in the form of discounts, deals, rewards or the like. Oftentimes, a promotional offering may be presented to a consumer in the form of an electronic correspondence that is transmitted at certain times throughout a given time period (e.g. throughout the day).

### BRIEF SUMMARY

An apparatus and method for analyzing electronic correspondences that include one or more promotions is disclosed.

According to an aspect of the invention, a method is provided for determining a mix of promotions for inclusion in a promotion system, the method comprising: determining a target number of promotions to offer in the promotion system of a given market; determining a target revenue for the market; accessing performance data for promotions offered in the market; analyzing the performance data; generating a promotion portfolio including one or more promotions based on the target number of promotions and the analysis of the performance data; generating a projected reward and projected risk for the promotion portfolio, and selecting the promotion portfolio in response to determining that the projected reward at least meets the target revenue and the projected risk is within an allowable value.

According to another aspect of the present invention, a method is provided for determining a mix of promotions for inclusion in a promotion system, the method comprising: determining a target number of promotions to offer in the promotion system of a given market; determining a target revenue for the market; accessing performance data for promotions offered in the market; analyzing the performance data; generating a plurality of promotion portfolios including one or more promotions based on the target number of promotions and the analysis of the performance data; generating a projected revenue and projected risk for each of the plurality of promotion portfolios, and selecting a promotion portfolio that meets a set criteria of revenue and risk.

According to another aspect of the present invention, an apparatus is provided for determining a mix of promotions for inclusion in a promotion offering system. The apparatus includes at least one processor and at least one memory including computer program code, the at least one memory and the computer program code configured to, with the at least one processor, cause the apparatus to: determine a target number of promotions; determine a target revenue for the market; access performance data for promotions offered in the market; analyze the performance data; generate a promotion portfolio including one or more promotions based on the target number of promotions and the analysis of the performance data; generate a projected reward and projected risk for the promotion portfolio, and select a promotion portfolio if the projected reward at least meets the target revenue and the projected risk is within an allowable value.

According to another aspect of the present invention, an apparatus is provided for determining a mix of promotions for inclusion in a promotion system. The apparatus includes at least one processor and at least one memory including computer program code, the at least one memory and the computer program code configured to, with the at least one processor, cause the apparatus to: determine a target number of promotions; determine a target revenue for the market; access performance data for promotions offered in the market; analyze the performance data; generate a plurality of promotion portfolios including one or more promotions based on the target number of promotions and the analysis of the performance data; generate a projected revenue and projected risk for each of the plurality of promotion portfolios, and select a promotion portfolio that meets a set criteria of reward value and risk value.

According to another aspect of the present invention, a computer program product is provided for determining a mix of promotions for inclusion in a promotion system. The computer program product includes at least one non-transitory computer-readable storage medium having computer-executable program code portions stored therein, the computer-executable program code portions comprising program code instructions that, when executed, cause an apparatus to: determine a target number of promotions; determine a target revenue for the market; access performance data for promotions offered in the market; analyze the performance data; generate a promotion portfolio including one or more promotions based on the target number of promotions and the analysis of the performance data; generate a projected reward and projected risk for the promotion portfolio, and select a promotion portfolio if the projected reward at least meets the target revenue and the projected risk is within an allowable value.

According to another aspect of the present invention, a computer program product is provided for determining a mix of promotions for inclusion in a promotion system. The computer program product includes at least one non-transitory computer-readable storage medium having computer-executable program code portions stored therein, the computer-executable program code portions comprising program code instructions that, when executed, cause an apparatus to: determine a target number of promotions; determine a target revenue for the market; access performance data for promotions offered in the market; analyze the performance data; generate a plurality of promotion portfolios including one or more promotions based on the target number of promotions and the analysis of the performance data; generate a projected revenue and projected risk for each of the plurality of promotion portfolios, and select a promotion portfolio that meets a set criteria of reward value and risk value.

According to another aspect of the present invention, a computer program product is provided for assigning a merchant account to a representative's collection of merchant accounts. The computer program product comprising at least one non-transitory computer-readable storage medium having computer-executable program code portions stored therein, the computer-executable program code portions comprising program code instructions that, when executed, cause an apparatus to: determine whether a merchant value associated with the merchant of the merchant account is above a threshold value, and increasing a weighted value of the merchant account in response to the merchant value being over the first threshold amount; determine whether the merchant account was previously assigned to the representative, and increasing the weighted value in response to the merchant account not being previously assigned to the representative; determine whether the merchant value ranks higher in the representative's collection of merchant accounts compared to the ranking of the merchant value in other collections of merchant accounts, and increasing the weighted value in response to the merchant value ranking higher in the representative's collection of merchant accounts; determine whether the representative is considered new, and increasing the weighted value in response to the representative being considered new; determine whether the representative's book of merchants satisfies a standard composition of merchant accounts, and increasing the weighted value if the representative's book of merchants does not satisfy the standard composition of merchant accounts; determine whether the representative has a closing rate of merchant accounts that is greater than a threshold rate, and increasing the weighted value in response to the representative having a closing rate that is greater than the threshold rate; determine whether the representative has a relationship with the merchant, and increasing the weighted value in response to the representative having a relationship with the merchant, and include the merchant account in the representative's collection of merchants if the weighted value is greater than a set value.

Other systems, methods, and features will be, or will become apparent to one with skill in the art upon examination of the following figures and detailed description. It is intended that all such additional systems, methods, and features included within this description, be within the scope of the disclosure, and be protected by the following claims.

### BRIEF DESCRIPTION OF THE DRAWINGS

The present invention may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 illustrates a representation of a network and a plurality of devices that interact with the network, according to the present invention;

FIG. 2 illustrates an overview of a number of inputs that go into an analytical model in order to obtain one or more proposed portfolios of promotions, according to the present invention;

FIG. 3A illustrates a flow chart describing an overview of a process for determining a diverse mix of promotions to include in an inventory of promotions for a promotion offering system, according to the present invention;

FIG. 3B illustrates a detailed view of a flow chart describing an overview for determining a proposed portfolio of promotions, according to the present invention;

FIG. 3C illustrates a graph that plots a risk value against reward value for a number of proposed portfolios, according to the present invention;

FIG. 3D illustrates a table describing the composition of proposed portfolios and associated risk and reward values, according to the present invention;

FIG. 3E illustrates a table describing the composition of proposed portfolios and associated risk and reward values, according to the present invention;

FIG. 4A illustrates a flow chart describing an overview of a process for determining a diverse mix of promotions to include in an inventory of promotions for a promotion offering system, according to the present invention;

FIG. 4B illustrates a table containing risk and reward values corresponding to a number of proposed portfolios, according to the present invention;

FIG. 5 illustrates an overview of a number of inputs that go into an analytical model in order to obtain one or more proposed portfolios of promotions, according to the present invention;

FIG. 6 illustrates a flow chart describing an overview of a process for determining a diverse mix of promotions to include in an inventory of promotions for a promotion offering system, according to the present invention;

FIGS. 7A through 7C illustrate a flow chart describing a process for allocating an unassigned merchant to a representative's book of merchants, according to the present invention; and

FIG. 8 is a general computer system, programmable to be a specific computer system, which may represent any of the computing devices referenced herein.

### DETAILED DESCRIPTION

The present invention as described herein may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. It should be noted that promotions and deals are recited in this disclosure to be understood as being interchangeable, unless specifically stated otherwise.

A promotion may include any type of reward, discount, coupon, credit, deal, voucher or the like used toward part (or all) of the purchase of a product or a service. The promotion may also include merchandise goods that are offered for sale. For instance, goods promotions may include offers for sale of clothing, electronic devices, school supplies, jewelry, sporting goods, kitchen goods, cosmetic goods and the like. The promotion may be offered as part of a larger promotion program, or the promotion may be offered as a stand-alone one-time promotion.

In an effort to better distinguish and identify the promotion, the promotion may be identified by one or more attributes, such as the merchant offering the promotion (e.g., “XYZ coffee shop”), the location of the promotion, the amount or price range of the promotion, the category of the promotion (such as a restaurant promotion, a spa promotion, a travel promotion, a local promotion, etc.), the sub-category of the promotion (such as a Japanese restaurant, a Massage promotion, a Caribbean cruise promotion, and a local farmer's market promotion, etc.), amount of discount offered by the promotion, time at which the promotion is likely to be purchased by a consumer (e.g., a breakfast meal promotion may have a greater likelihood of being purchased by a consumer in the morning time), time at which the promotion is redeemable (e.g., a breakfast meal promotion may only be redeemable during breakfast hours), time or time period for which the promotion is related to (e.g., a breakfast meal promotion is related to a morning time period), or the like. Any one of the described attributes may then be used to define a corresponding promotion category.

The promotion offering system 102 has a portfolio of promotions in a given market (e.g., city, metropolitan area, state, etc.) from which to offer promotions to consumers in the given market. The portfolio of promotions is typically the result of happenstance, and not planning. However it is an objective of the present invention to generate portfolios that are filled with promotions that are more relevant to the given market by referencing various performance indicia for the market that are made available. Further description is provided below.

In one aspect of the invention, the promotion offering system 102 is configured to analyze one or more aspects of the given market (such as the target number of promotions in the market, the target revenue in the market, and/or the historical performance data for promotions in the given market (including an estimate of future demand based on historical performance)), and generate one or more proposed portfolios of promotions for the given market.

Each of the proposed portfolios has an associated risk and reward. In particular, each proposed portfolio is comprised of various mixes of promotions from across different promotion categories, and/or sub-categories. In turn, each proposed portfolio may have a calculated risk and reward prediction. The promotion offering system 102 may analyze the risk and reward predictions in evaluating which of the proposed portfolios to select for the given market. The selected proposed portfolio may then be compared with the existing portfolio in the given market to determine differences between the selected proposed portfolio and the existing portfolio. In particular, in response to the comparison, the promotion offering system 102 may determine: (1) which promotions (e.g., which categories/subcategories of promotions) the existing portfolio has fewer than the selected proposed portfolio; and/or (2) which promotions the existing portfolio has more than the selected proposed portfolio. In response to this determination, the portfolio for a given market may be adjusted. For example, in the instance where the existing portfolio has fewer promotions than the selected proposed portfolio, additional promotions (such as in the categories/subcategories in the selected proposed portfolio) may be obtained. As another example, in the instance where the existing portfolio has more promotions than the selected proposed portfolio, the promotion offering system may treat the extra promotions in the existing portfolio differently (such as removing the extra promotions, or reducing the likelihood that the extra promotions will be offered). In this way, the portfolio for a given market may have the desired diversity of promotions.

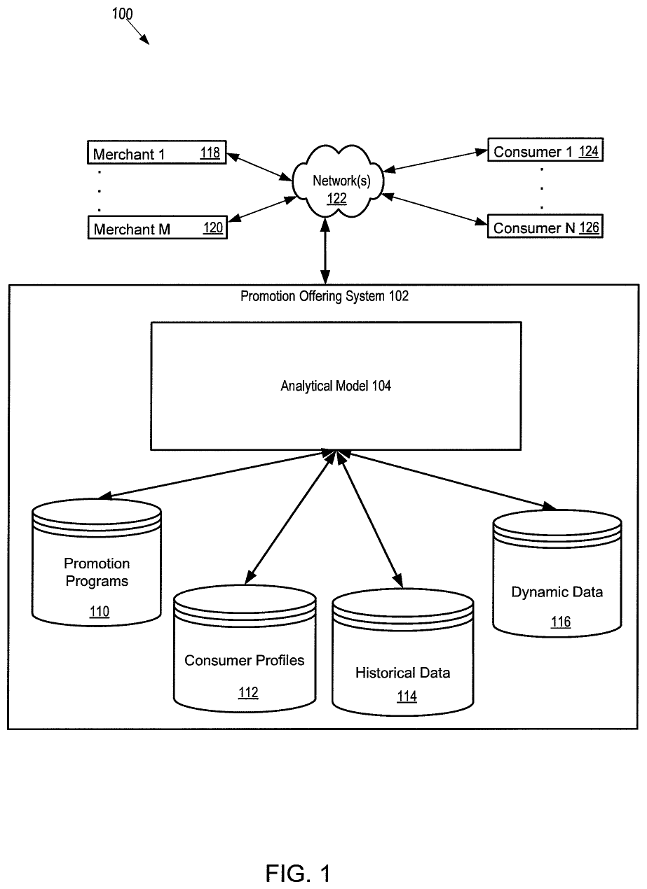

FIG. 1 illustrates an overview for a promotion system 100 configured to offer promotions for promotion programs. The promotion system 100 includes a promotion offering system 102, which communicates via one or more networks 122 with consumers, such as consumer 1 (124) to consumer N (126), and with merchants, such as merchant 1 (118) to merchant M (120). The promotion offering system 102 also includes analytical model 104 that is in communication with databases 110, 112, 114, 116.

As previously described, the promotion system 100 may correspond to a given market for offering promotions. For instance the market may be a neighborhood (e.g., Lincoln Park), city (e.g. Chicago), metropolitan area (e.g., Chicagoland area that includes Chicago and surrounding suburbs of Chicago), state (e.g., Illinois), or other identifiable market area. By defining the promotion system 100 as corresponding to an identifiable market, certain performance targets may be implemented for defining the performance of promotions in the market.

For instance, a target number of promotions may be defined for a given market. The target number of promotions defines the number of promotions in an inventory of promotions that are available for presentation to a consumer in the given market at any given time. The inventory may be comprised of a portfolio of promotions. The value of the target number may be set based on an optimal number of promotions to keep available for the given market. For example, if the target number of promotions for the market is set for one hundred (100) active promotions in the market at any given time, as old promotions expire new promotions may be sought and acquired to meet the 100 promotion target for the given market. Further description on how the promotion system 100 achieves the targeted number of promotions available in the promotion system 100 is provided in more detail below.

In addition or alternatively, the target number may be set to be a reflection of a predicted demand for promotions in the given market. In this way, the target number of promotions may be based on a predicted demand for promotions in the given market. A higher demand for promotions in the given market will correlate to a higher target number, and conversely a lower demand for promotions in the given market will correlate to a lower target number. The demand value may be determined based on predicted performance values for promotions in the promotion inventory of the given market. For instance, each of the promotions included in the promotion inventory for the given market may have a corresponding predicted conversion rate (e.g., probability of being purchased by a consumer). The analytical model 104 may then reference each of the individual predicted conversion rates to generate an overall conversion rate value for the promotion inventory of the given market. The conversion rate value for the promotion inventory of the given market may then be referenced by the analytical model 104 to determine a predicted demand for promotions in the given market. The analytical model 104 may also take into account predicted market condition information for the given market such as predicted population growth, predicted income growth, predicted inflation and predicted promotion system growth when determining the predicted demand for the given market. The predicted demand may then be referenced by the analytical model 104 to determine the target number of promotions to have in a promotion inventory for the given market. The list of predicted market condition information is provided for exemplary purposes only; other information is contemplated.

The predicted demand value may be in terms of a number of promotions across each promotion category, and/or sub-category, that is expected to be required to meet the demand in the given market. Referencing the predicted demand for the given market allows the determination of the target number of promotions to have in a promotion inventory of the given market to be more focused on relevant information pertaining to the given market.

In addition, a target revenue amount may be set for the market. The target revenue obtained from the promotions may be defined by gross profits, net profits, gross sales or other similar measurement of revenue. The target revenue may be taken for a given time period such as revenue in a day, week, month, year or other similar measurement of time. For instance, the target revenue may be defined as $5 million for a 3-month period. The target revenue amount may be set by the promotion system 100 based on desired target revenues for the promotion system.

In addition or alternatively, the target revenue amount for the given market may be set to be a reflection of a predicted demand for promotions in the given market. In this way, the target revenue amount for the given market may be based on past performance data for the given market. This provides a more focused target revenue value that is based on relevant information to the given market. The predicted demand value may be obtained according to the method described above.

Further description on how the promotion system 100 is able to reference the target revenue for the market when generating a number of proposed portfolios of available promotions that includes a mix of promotions across different categories is provided in more detail below.

The analytical model 104 may include one or more components for determining the target number of promotions for the market and the target revenue to achieve in the market. The analytical model 104 may also include one or more components for generating proposed portfolios of promotions that include a diverse mix of promotions from across different promotion categories and/or sub-categories.

The analytical model 104 may also calculate risk and reward predictions for each set of proposed portfolios that are generated. The reward may be a predicted calculation of a revenue return from the promotions that are included in the corresponding proposed portfolio of promotions. The risk may be based on a probability that the performance of the promotions included in the corresponding proposed portfolio of available promotions will not achieve the targeted revenue goal for the market. One example of calculating the risk may be calculating the historical variance of promotions that are in a particular promotion category. Each of the risk and reward calculations may be based on past historical performance data for promotions in the market, as described below.

The analytical model 104 may also include one or more components for generating an electronic correspondence for including the one or more promotions for presentation to the consumer according to this invention. The electronic correspondence may be presented to the consumer by transmission, or interactive display, of the electronic correspondence taking the form of an email, SMS text message, webpage inbox message, VOIP voice message, real-time webpage content presentation, mobile push notifications or other similar types of electronic correspondences.

The analytical model 104 communicates with one or more databases that are part of (or work in conjunction with) the promotion offering system 102 such as a promotion programs database 110, consumer profiles database 112, historical data database 114 and dynamic data database 116. The analytical model 104 may access the databases 110, 112, 114 and 116 in order to obtain performance data on the various promotions in the promotion system 100 that have been offered to consumers in the market, both in the past and currently.

The promotion programs database 110 is configured to store data detailing various promotions and promotion programs that are available for offer in the promotion offering system 102. In order to input promotion program information into the promotions program database 110, merchants may optionally communicate via the networks 122 with the promotion offering system 102 to input the information detailing the various promotion program offerings. In order to meet the targeted number of promotions for the market, the promotion system 100 may contact established merchants in the promotion system 100 to see whether the merchants wish to participate in the promotion system 100 again by offering a new promotion or by re-offering a previously offered promotion. The promotion system 100 may also contact new potential merchants that are in the market to join the promotion system 100 in order to meet the targeted number of promotions for the market.

The consumer profiles database 112 includes profiles and sub-profiles for the consumers (consumer 1 (124) to consumer N (126)) that are included in the promotion system 100. Each profile or sub-profile includes one or more consumer attributes that describe the consumer. The consumer attributes may include, but are not limited to, the consumer's name, consumer's age, consumer's address (such as the consumer's home address and/or the consumer's work address), consumer's occupation, consumer's educational background, consumer's previously accepted and/or rejected promotion program offerings, consumer's gender and the like.

The consumer may additionally select one or more specific consumer focused deal types (DTs) for inclusion in the consumer's consumer profile. The DTs may be defined in one of several ways.

In one embodiment, DTs are defined as a taxonomy different from categories/subcategories. In particular, categories/subcategories are one type of taxonomy or classification, and DTs are another distinct type of taxonomy or classification.

In another embodiment, DTs are defined based on the structure of the taxonomy. For example, categories/subcategories may be defined as a hierarchy with multiple layers. More specifically, the categories/subcategories include at least two levels, one level defining categories and a sub-level defining the subcategories. In contrast, the DTs may be defined as a single layer without multiple levels. More specifically, the DTs may have a horizontal relationship with one another, but not a vertical relationship owing to the single layer hierarchy.

In still another embodiment, the DTs may be defined with respect to, or independent of, categories and/or subcategories. In one aspect, the definition of the DTs may be dependent on a category and/or subcategory. For example, one of the DTs may comprise “adrenaline”. The DT for “adrenaline” may be defined based on a look-up table that correlates to particular subcategories, such as the subcategory “hot air balloons”, the subcategory “skydiving”, the subcategory “scuba diving”, etc. In this way, the DTs may be defined based on multiple categories and/or subcategories.

In another aspect, the definition of the DTs may be independent of category and/or subcategory. For example, the DTs may be manually assigned to be associated with one or more certain promotions. The certain promotions, in turn, will be associated to one or more promotion categories. In this way, the assignment of the DTs is not based on a direct correlation with promotion categories or subcategories but rather a direct correlation to one or more promotions that are manually assigned to the DT. Further, a DT may be indirectly associated to promotion categories or subcategories through an association with a corresponding promotion. Similarly, a promotion category or subcategory may not be directly related to a DT, but rather may be related to one or more promotions. The one or more promotions may, in turn, be associated with one or more DTs. In this way a promotion category or subcategory may be indirectly associated with one or more DTs.

In yet another embodiment, the DTs may be based on one or more aspects of the consumer to which the DT is assigned. For example, one or more DTs may also be suggested to be associated with the consumer based on the consumer's past behavior within the promotion system 100. In this way, a DT is distinct from any one promotion category, and serves to define one or more aspects of the consumer. More particularly, the DT is indicative of one or more aspects of the consumer, whereas the categories/subcategories are indicative of one or more aspects of the merchant. For instance, a DT is indicative of a characteristic of the consumer, such as a description of a personality or trait of the consumer, a description of an interest or pursuit of the consumer, and/or a description of an activity or action of the consumer.

In still another embodiment, both the DTs and the categories/subcategories are defined based on the merchant, but defined based on different aspects of the merchant. As discussed above, for example, the category of the promotion may comprise a restaurant promotion, a spa promotion, a travel promotion, a local promotion, and the respective sub-category of the promotion may comprise a Japanese restaurant, a Massage promotion, a Caribbean cruise promotion, and a local farmer's market promotion. In contrast, the DTs may include “family friendly”, which may comprise a “family friendly” restaurant, “family friendly” Japanese restaurant, etc. So that the DTs describe an aspect of the merchant which is separate from the category and/or subcategory description.

In yet another embodiment, the DTs are distinguished from categories/subcategories in their application and/or use. For example, the DTs may be assigned to a promotion in a different way from the assigning of the category/subcategory of the promotion. As another example, the DTs may be used in a different way from the category/subcategory in determining whether to present the promotion to the consumer. More specifically, the category/subcategory may be used in one step (such as the initial estimate of the probability of acceptance of the promotion) and the DTs may be used in another step (such as to determine a correction factor), as discussed in more detail below.

A DT may include, for example, a food interest group, outdoors interest group, home improvement interest group, children's related interest group, pampering and leisure interest group, pet enthusiast's interest group, healthy life style interest group, extreme sports interest group, traveling interest group, music and concert interest group and car enthusiast interest group among others. The examples given for DT are merely for illustration purposes. Other DTs are contemplated.

In order to use DTs for selecting promotions, the promotions may be assigned or associated with one or more DTs (such as by assigning a tag indicating an association to a corresponding DT). The promotion may be associated with a DT either automatically or manually. For example, the promotion offering system 102 may automatically assign a DT based on one or more attributes descriptive of the promotion and one or more attributes descriptive of the DT. More specifically, a promotion may be associated with a DT if the promotion shares one or more of the same, or similar, attributes as the DT. In this way, the promotion offering system 102 is able to tailor the presentation of promotions to the consumer by selecting promotions that are tagged with one or more DTs that match the DTs of the consumer, as described in more detail below.

The DTs that are selected by the consumer, or suggested by the promotion offering system 102, may be incorporated into the consumer's profile. The associated DT information from the consumer profile may then be referenced when determining one or more promotions to present to the consumer, as described below.

The historical data database 114 includes information detailing the past performance of promotion offerings that have been presented in the promotion offering system 102 in previous times. The historical data database 114 may include, but is not limited to, rates of acceptances of specific promotions and promotion programs, attributes of consumers that accepted or rejected specific promotion programs, times at which previous emails were reviewed by a consumer, and the like. The historical data database 114 may also include historical performance data for the promotions in the promotion system 100 that details revenue data in the form of gross profits, gross sales or net profits obtained from the purchase of promotions. Profits may be defined as a set amount that is received for each promotion that is purchased by a consumer, a percentage of the value of a deal that is being offered by a purchased promotion, a percentage of the amount a consumer spends when a promotion is purchased, or some other amount that is agreed upon with a merchant for a promotion that has been purchased. This historical performance data may then be referenced as part of an analysis executed by the analytical model 104 for determining a proposed portfolio of promotions taken from a mix of promotion categories.

The dynamic data database 116 includes information detailing the past performance of a promotion program offering that is currently active in the promotion offering system 102. Therefore, while a promotion program referenced in the dynamic data database 116 is currently active, the data stored in the dynamic data database 116 may include performance data of the active promotion program from a previous time period.

Although FIG. 1 has been illustrated to show separate databases 110, 112, 114 and 116, FIG. 1 has been illustrated for demonstrative purposes only, and it is contemplated to have the databases 110, 112, 114 and 116 arranged in any combination of one or more memories/storage units.

Any one or more of the databases may also include a repository of deals, such as disclosed in U.S. application Ser. No. 13/460,745, incorporated by reference in its entirety. Alternatively, the repository of deals may be stored separately from the databases 110, 112, 114, 116. In any case, the promotion offering system 102 may have multiple deal repositories, such as a first bank of deals in which deals are offered to consumers for a shorter period of time (such as up to 1 week) and a second bank of deals in which deals are offered to consumers for a longer period of time (such as up to 6 months).

By utilizing one or more of these databases 110, 112, 114, 116, the promotion system 100 is configured to store performance data for a plurality of promotions that have been offered in the promotion system 100 at some time. The promotion system 100 also stores on one or more of the databases 110, 112, 114, 116 information pertaining to a portfolio of one or more promotions that comprises an inventory of promotions to be offered to a consumer in the market. The promotion system 100 is further able to store information defining the performance targets, for instance the target number of promotions in the portfolio and target revenue for the market, in one or more of the databases 110, 112, 114, 116. The information stored in the databases 110, 112, 114, 116 may then be referenced by the analytical model 104 in order to determine one or more proposed portfolios that include an assortment of promotions from across different promotion categories for keeping available in the market at any given time.

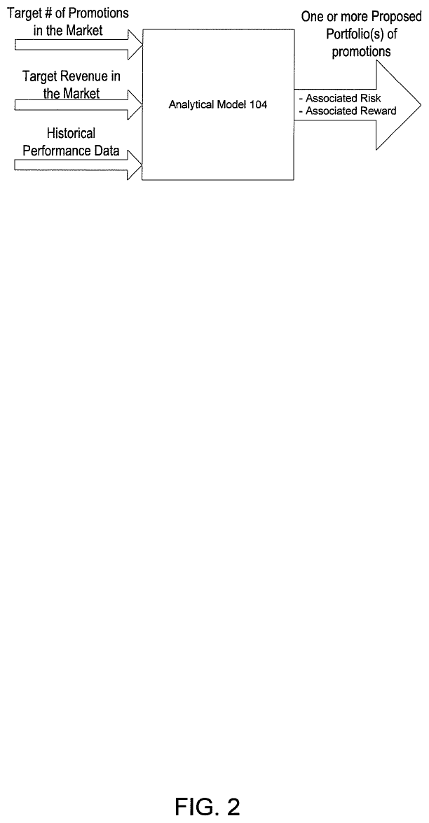

Providing a diverse portfolio of promotions from across different promotion categories allows for a more reasoned presentation of promotions to a market of consumers based on one or more factors. FIG. 2 illustrates three such factors in the determination of a proposed portfolio. The first factor is a targeted number of promotions to have available in a given market. The target number of promotions may be determined randomly. In addition or alternatively, the target number of promotions may be determined based on historical performance data on promotions in the market, where the historical performance data indicates that the target number of promotions in the market has historically provided better performance. For instance, historical performance data may indicate that for a larger market, a higher target number results in better performance (e.g., higher revenue from the purchase of promotions, or a greater diversity of promotions that are offered to consumers). In addition or alternatively, the target number may be directly related to the size of the given market. For instance, the number of consumers in the given market will be directly correlated to the target number.

The second factor is a target revenue for achieving in the given market, where the revenue may be defined as any one of the methods described throughout this disclosure.

The third factor is historical performance data of promotions in the given market. The historical performance data may be comprised of any one of rates of purchases of specific promotion programs, attributes of consumers that purchased or rejected specific promotion programs, times at which previous emails were reviewed by a consumer, revenue data in the form of gross profits, gross sales or net profits obtained for the sale of promotions in the market. These examples of performance data are provided for illustrative purposes only, and other types of performance data are contemplated.

The three input factors described above are illustrated in FIG. 2 as inputs to the analytical model 104. From these three input factors, the analytical model 104 is configured to generate, and/or define, one or more proposed portfolio(s) of available promotions. Each of the one or more proposed portfolios is comprised of one or more promotions that are taken from a diverse assortment of different promotion categories.

Promotions in the portfolio of available promotions may have a set shelf life during which they are available for presentation to consumers. For instance, the shelf life of a promotion may be time-based such that the promotion is available for presentation to consumers for a day, week, month, year, until a merchant requests the promotion be made unavailable, or other describable time period. In addition or alternatively, the shelf life of a promotion may be numbers-based, such that the promotion is only available to be presented, or bought, by a consumer a set number of times before it is considered to be expired.

In this way, expired promotions are no longer available for presentation to consumers. In an effort to maintain the target number of promotions that are available in the portfolio, new promotions may be solicited from merchants to make available for presentation to consumers. In addition, an expired promotion may be re-introduced after receiving merchant approval so that the expired promotion may once again be made available for presentation to a consumer. Further description is provided below.

In addition, the analytical model 104 is configured to calculate a risk value and reward value for each of the one or more proposed portfolio(s) that are generated, and/or defined. From the one or more proposed portfolio(s) that are generated, one proposed portfolio may be selected upon which to model the inventory of the market. The selection may be based, at least in part, by comparing the risk and reward values for the proposed portfolio(s) against one or more of the three input factors described above. For instance, the selection may be made, at least in part, by comparing the risk and reward values for the proposed portfolio(s) against the target revenue for the market. From the selected proposed portfolio, the promotion system 100 may then make efforts to maintain an inventory of available promotions that matches the diverse mix of promotions found in the selected proposed portfolio.

By intelligently modeling a portfolio of available promotions to include promotions from across a diverse mix of promotion categories, the promotion system 100 may optimize potential rewards (e.g., revenue) while minimizing potential risks. Further description is provided below.

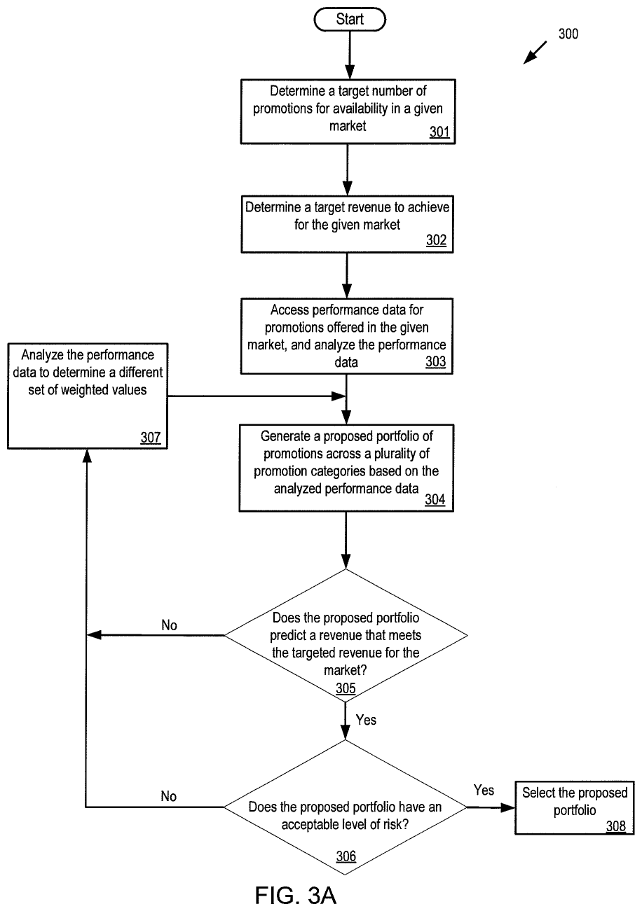

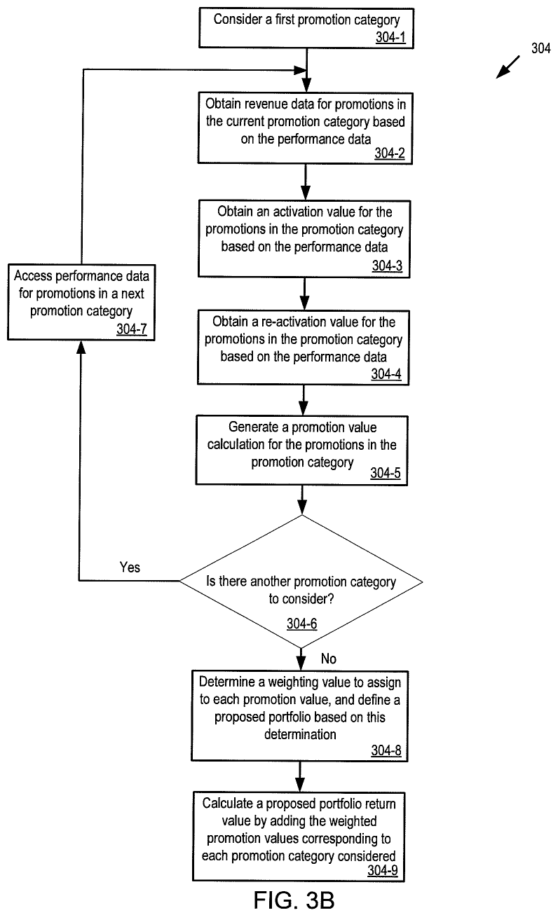

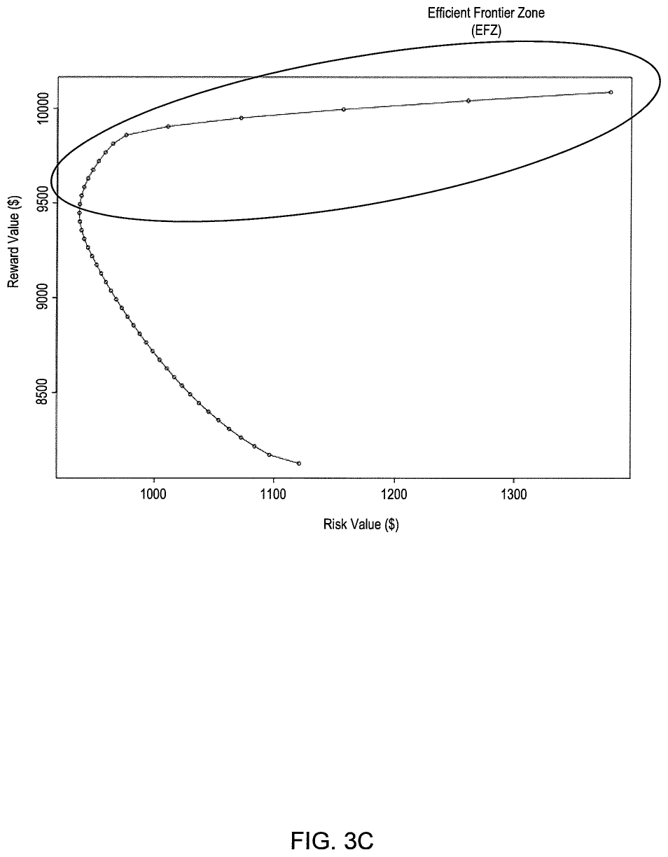

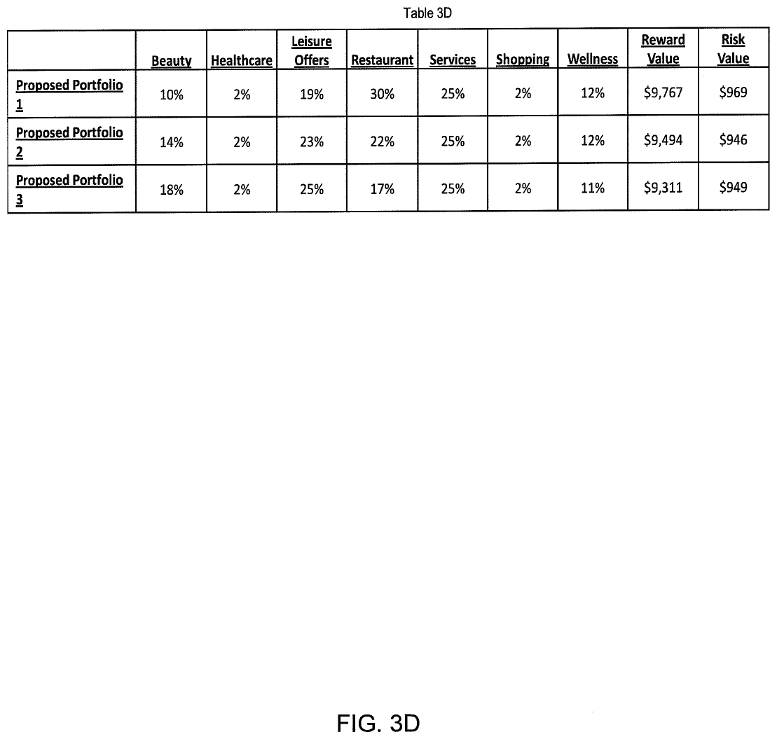

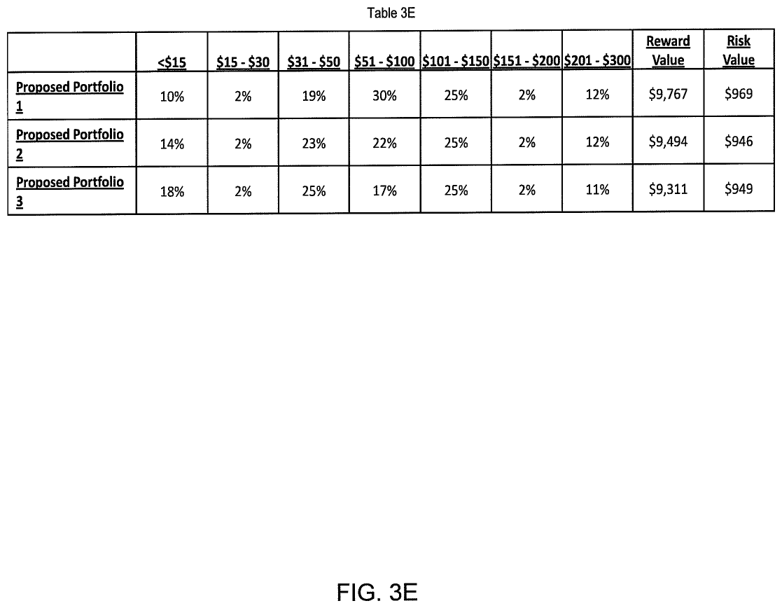

FIG. 3A illustrates a flow chart 300 describing an overview of a process for selecting a diverse portfolio of promotions to include in an inventory of promotions in a given market according to the present invention. According to the process described in flow chart 300, a portfolio may be selected from amongst one or more proposed portfolios that satisfy one or more selection thresholds. Further description is provided below.

At 301, a set target number of promotions may be allocated to remain available in an inventory for the promotion system 100 of the given market. The actual target number value may be based on a size of the given market. For instance, the target number of promotions to keep in an inventory of a larger market (e.g., by population or land area) may be higher, and conversely the target number of promotions to keep in an inventory of a smaller market (e.g., by population or land area) may be smaller.

In addition or alternatively, the target number value may be correlated to past performance data indicating a minimum number of promotions that should be kept available in the inventory of the given market in order to offer consumers an acceptable level of promotion diversity. For example, the target number of promotions may be determined based on an expected demand for promotions. More specifically, the analytical model 104 may estimate the consumer demand (and in turn, the number of promotions the estimated consumer demand requires) for a future period. The estimated consumer demand may be used to determine the target number of promotions. Promotion diversity may be based on offering promotions across a diverse mix of promotion categories, or sub-categories.

For exemplary purposes, it is assumed that the given market is for the Midwest region in the United States, and the target number of promotions to have available is 100 promotions.

At 302, a target revenue to achieve from the sale of promotions in the given market is determined. For exemplary purposes, it is assumed that the target revenue to achieve from sales of promotions in the Midwest market for a given month of time is $9,500.

At 303, performance data corresponding to promotions that have previously, and/or are currently, available in the market are accessed and analyzed. For instance, the performance data may be stored in one or more of the databases 110, 112, 114, 116 or the like. Also, the analytical model 104 of the promotion offering system 102 may be tasked with performing the analysis of the performance data at 303.

Based on the analysis of the performance data at 303, at 304 a proposed portfolio of promotions that includes promotions from across a diverse mix of different promotion categories is generated. A more detailed description for the process involved at 304 in FIG. 3A is provided by block 304 illustrated in FIG. 3B.

FIG. 3B is a more detailed illustration of the processes involved at 304 in flow chart 300.

At 304-1, a first promotion category is considered. The first promotion category may be any one of the promotion categories described throughout this disclosure. For exemplary purposes, the first promotion category may be beauty related promotions.

At 304-2, revenue value data for each individual promotion belonging to the first promotion category is obtained from the accessed and analyzed performance data. The revenue value data may be defined by any one of the methods described above. For exemplary purposes, the obtained revenue value data at 304-2 may be defined as an average gross profit (GP) for a respective promotion in the first promotion category, such that the performance data indicates the respective promotion (e.g., beauty related promotions) has generated $10,000 in gross profit revenue from past purchases.

At 304-3, an activation value for each individual promotion belonging to the first promotion category is obtained based on the accessed and analyzed performance data. The activation value is a representation of a respective promotion's value based on the number of times the respective promotion was purchased by an active consumer in the promotion system 100 of the market. An active customer may be defined as a consumer who has made his/her first purchase on that promotion. The overall activation value, then, can be calculated by multiplying the activation value (e.g., $20) by the number of times (e.g., 100) an active consumer purchased the respective promotion that belongs to the first promotion category. The overall activation value is an estimated monetary value that is calculated for the respective promotion keeping active consumers engaged in the promotion system 100 by enticing them to purchase the respective promotion. Then according to the exemplary values provided, the overall activation value (OAV) for the respective promotion in the first promotion category is calculated to be:

OAV=(activation value)*(number of consumers that have purchased the respective promotion that belongs in the first promotion category and for whom this promotion was the first promotion purchased), or

OAV=($20)*(100 consumers)=$2,000.

At 304-4, a re-activation value for each individual promotion belonging to the first promotion category is obtained based on the accessed and analyzed performance data. The re-activation value is a representation of a respective promotion's value based on the number of times the respective promotion was purchased by an inactive consumer in the promotion system 100. An inactive consumer may be defined based on a number of days since the consumer has purchased a promotion. For instance, the consumer may be considered to be an inactive consumer if the consumer has not purchased a promotion within the last 90 days or more. The overall re-activation value, then, can be calculated by multiplying the re-activation value (e.g., $25) by the number of times (e.g., 200) an inactive consumer purchased the respective promotion that belongs to the first promotion category. The overall re-activation value is an estimated monetary value that is calculated for the respective promotion re-activating consumers that have lapsed, or have been inactive for a significant amount of time. Then, according to the exemplary values provided, the overall re-activation value (ORAV) for the respective promotion in the first promotion category is calculated to be:

ORAV=(re-activation value)*(number of inactive consumers that have purchased the respective promotion that belongs in the first promotion category), or

ORAV=($25)*(200 inactive consumers)=$5,000.

At 304-5, a promotion value (PV) may be calculated for the individual respective promotion in the first promotion category. The promotion value may be calculated according to:

PV=Revenue Value+Activation Value+Re-Activation Value, or

PV_{respective promotion}=$10,000+$2,000+$5,000=$17,000.

Although not specifically illustrated at 304-5, a promotion value is calculated for each individual promotion that is included in the first promotion category according to the disclosure provided above with respect to the respective promotion. By calculating the promotion value for each promotion in the first promotion category, an average promotion value (APV) for promotions in the first promotion category may be calculated. In addition, a standard deviation for the promotions in the first promotion category may be calculated. The average promotion value for the first promotion category may be considered the reward value (e.g, predicted revenue) for the first promotion category. The standard deviation of promotion values for the first promotion category may be considered the risk value of the first promotion category.

Although the PV has been described as the sum of the Revenue Value, Activation Value and Re-Activation Value, it is within the scope of the invention for the PV to be any combination of one or more of these individual values.

At 304-6, a determination is made as to whether another promotion category is to be considered. If a determination is made at 304-6 that another promotion category is to be considered for the current proposed profile, at 304-7 another promotion is considered by accessing and analyzing performance data for the other promotion. Then, the processes described by 304-2 to 304-5 are repeated for each other promotion category that is to be considered. In this way, the reward value (e.g., average promotion value) and risk value (e.g., standard deviation of promotion values) for each promotion category that is considered may be calculated.

When a determination is made at 304-6 that there are no longer any promotion categories left to consider for the current proposed portfolio, at 304-8 weighting values are determined and applied to each APV that has been calculated for each of the promotion categories that have been considered for the proposed portfolio. The sum of each of the weighting values adds to 100%. By assigning a particular weighting value to a respective APV, the assigned weighting value will also represent a percentage within the proposed portfolio that will be comprised of promotions from a promotion category that corresponds to the respective APV. In this way, the composition of promotions across diverse promotion categories in the proposed portfolio will be based on the weighting values assigned to each respective APV.

For example, if the weighting value 10% is assigned to the APV for the beauty related promotion category, this indicates that 10% of promotions in the proposed portfolio should be comprised of promotions in the beauty related promotion category. This is the scenario illustrated in Table 2D. Table 2D illustrates Proposed Portfolio 1 as being comprised of 10% promotions from a Beauty related promotion category, 2% promotions from a Healthcare related promotion category, 19% promotions from a Leisure Offers related promotion category, 30% promotions from a Restaurant related promotion category, 25% promotions from a Services related promotion category, 2% promotions from a Shopping related promotion category, and 12% from a Wellness related promotion category. In this way, Proposed Portfolio 1 is comprised of promotions selected from across 7 different promotion categories. According to Proposed Portfolio 1 illustrated in Table 2D, the weighting values for each respective promotion category are as follows:

A %_{Beauty}=10%; B %_{Heatlhcare}=2%; C %_{Leisure Offers}=19%; D %_{Restaurant}=30%; E %_{Services}=25%; F %_{Shopping}=2%; G %_{Wellness}=12%

By adding up all of the weighting values for Proposed Portfolio 1, the sum is seen to equal 100%.

At 304-9, a proposed portfolio return value is calculated by adding each of the weighted APV. In this way, the proposed portfolio return value may generally be calculated according to the following:

Proposed Portfolio Return Value=(A %)*(APV_{A})+(B %)*(APV_{B})+ . . .

Specifically, the proposed portfolio return value for Proposed Portfolio 1 in Table 2D may be calculated according to the following:

Proposed Portfolio1 Return Value=(A %_{Beauty})*(APV_{Beauty})(B %_{Heatlhcare})*(APV_{Heatlhcare})+(C %_{Leisure Offers})*(APV_{Leisure Offers})+(D %_{Restaurant})*(APV_{Restaurant})+(E %_{Services})*(APV_{services})+(F %_{Shopping})*(APV_{Shopping})+(G %_{Wellness})*(APV_{Wellness})

The proposed portfolio return value is representative of a predicted revenue value that may be achieved if the promotion system 100 implements a set of available promotions across different promotion categories as identified by the proposed portfolio. In other words, the proposed portfolio return value may be considered to be the reward value for the proposed portfolio.

The risk value for the proposed portfolio represents a risk of missing the target revenue. To accomplish this, the risk of a promotion category may be the standard deviation (STD) of deal values for each promotion in the promotion category. For instance, the individual risk of the beauty promotion category will be the standard deviation of deal values calculated based on the historical performance of promotions in the beauty promotion category.

Then the overall risk for the proposed portfolio may be the weighted sum of the risk values obtained for each promotion category in the proposed portfolio:

Proposed Portfolio Risk Value=(A %)*(B %)*(STD_{A})*(STD_{B})*(CORR_{AB})+

Where the sum is applied over all pairs of categories A and B. Note that the CORR_{AB} is the coefficient of correlation between categories A and B.

Specifically, the proposed portfolio risk value for Proposed Portfolio 1 in Table 2D may be calculated according to the following:

Proposed Portfolio 1 Risk Value=SUM over all A, B {(A %_{Beauty})*(STD_{Beauty})*(B %_{Heatlhcare})*(STD_{Heatlhcare})*CORR_{AB}} where A, B belong to the set {Beauty, Healthcare, Leisure Offers, Restaurant, Shopping, and Wellness}.

Alternatively or in addition, in some embodiments the promotion category may be related to a price value of promotions. For instance, Table 3E illustrates promotion categories existing for promotions that are in the price range of less than $15, the price range of between $15-$30, the price range of between $31-$50, the price range of between $51-$100, the price range of between $101-$150, the price range of between $151-$200, and the price range of between $201-$300. The price ranges illustrated in Table 3E are provided for exemplary purposes only. Other promotion categories that correspond to promotions that belong in other price ranges are contemplated. The price range of the promotion category may relate to a value of the promotion, an amount discount offered by the promotion, or an amount of revenue receivable by the promotion system 100 when the promotion is purchased by a consumer.

Returning to flow chart 300, at 305 a determination is made whether the proposed portfolio that is generated at 304 projects a predicted revenue that at least meets the target revenue for the market that was determined at 302. The projected revenue for the projected portfolio is identified by the proposed portfolio's reward value that is calculated at 304-9 in flow chart 304 illustrated in FIG. 3B. If the determination at 305 finds that the proposed portfolio does not project revenue that at least meets the target revenue value from 302 ($9,500), then at 307 the performance data is analyzed again. The analysis of performance data at 307 results in the generation of a different set of weighted values that will be utilized when defining the next proposed portfolio at 304-8 in flow chart 304 illustrated in FIG. 3B. By altering the weighting values, a plurality of different proposed portfolios may be defined in the process described by flow chart 300. In this way a new proposed portfolio may be defined at 304 and the determination at 305 may be implemented once more on the new proposed portfolio.

The actual weighting values that are assigned to each APV for a given proposed portfolio that is defined according to the process described by flow chart 200 may be obtained according to, for example, the principles of at least one of the Markowitz portfolio management model, postmodern portfolio model, and continuous-time Merton model.

Each defined proposed portfolio is associated with a respective reward and risk as described above. For instance, Table 3D in FIG. 3D illustrates three unique proposed portfolios. Each of Proposed Portfolio 1, proposed portfolio 2 and Proposed Portfolio 3 is associated to its own unique composition of promotions across a diverse mix of promotion categories, and is associated to its own unique reward (e.g., promotion value) and risk values.

If the determination at 305 finds that the proposed portfolio does project revenue that at least meets the target revenue value from 302, then at 306 a next determination is made as to whether the proposed portfolio is associated with an acceptable level of risk.

If the level of risk associated with the proposed portfolio is determined to be an acceptable amount (e.g., the associated risk is less than a minimum threshold) at 306, then at 308 the proposed portfolio is selected. In this way, the diverse composition of promotions within the selected proposed profile will at least meet the target revenue, as determined at 305, and carry an acceptable level of risk, as determined at 306. In some embodiments, the acceptable level of risk may be the lowest level of risk from amongst the proposed profiles that are defined during the execution of the process described by flow chart 300.

FIG. 3C illustrates a graph that plots a risk value (x-axis) against a reward value (y-axis) for a plurality of proposed portfolios in accordance to the exemplary model referenced throughout the description of flow chart 300. The Efficient Frontier Zone encompasses the proposed portfolios that have been calculated to have an associated reward value that at least meets the target revenue for the market. In this case, the exemplary target revenue determined at 302 in flow chart 300 is set to be $9,500. Therefore, the Efficient Frontier Zone will cover all of the proposed portfolios that have been generated having an associated reward value (e.g., predicted revenue) that is greater than the target revenue. Then from the proposed promotions that are included within the Efficient Frontier Zone, each respective risk value may be taken into consideration.

In some situations, a proposed portfolio having a higher reward value may be enough to overlook a correspondingly higher risk value. In other situations, a lower reward value along with a lower risk value may be desirable, as long as the reward value is above the target revenue value. In this way, the proposed portfolio that is selected from within the Efficient Frontier Zone may depend on the circumstances of the time.

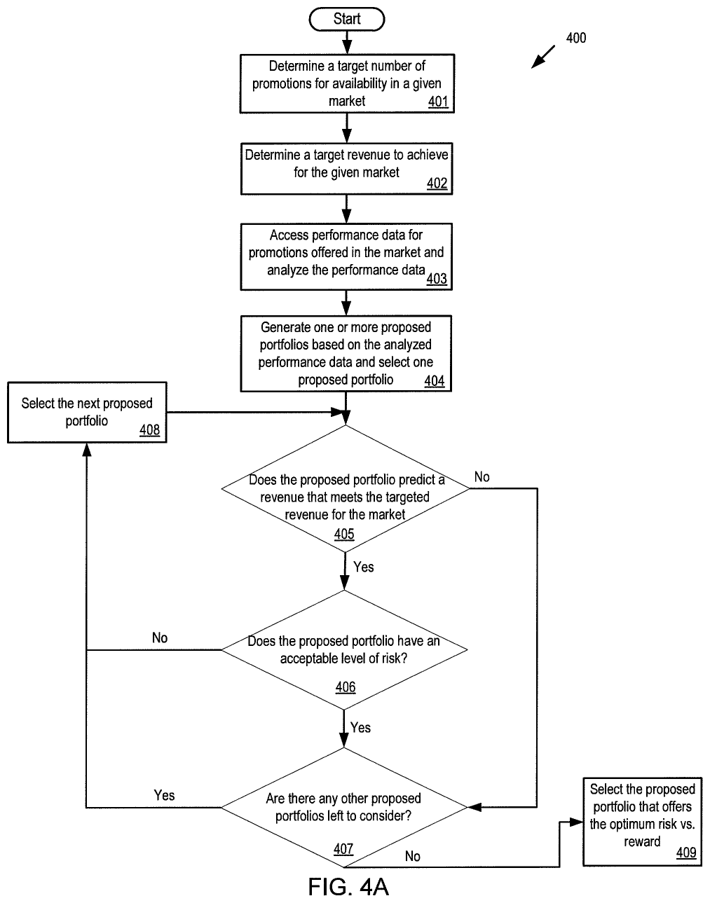

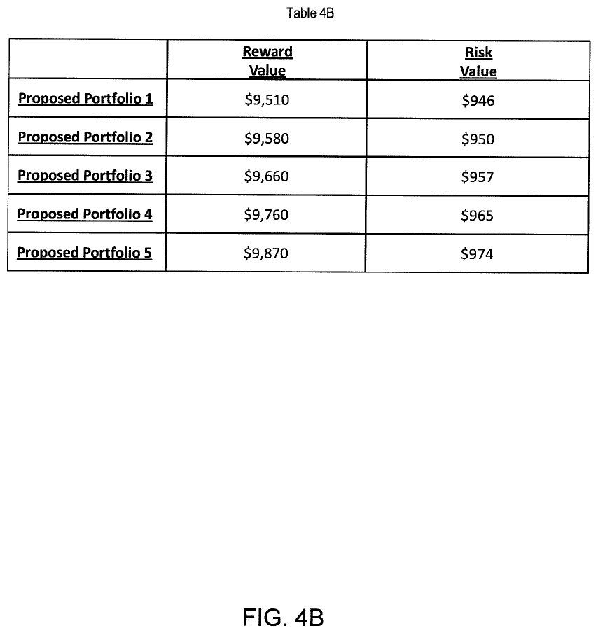

FIG. 4A illustrates a flow chart 400 describing an overview of a process for selecting a diverse portfolio of promotions to include in an inventory of promotions in a given market according to the present invention. According to the process described in flow chart 400, an optimum portfolio may be selected from amongst one or more proposed portfolios. Further description is provided below.

At 401, a target number of promotions to have available for a given market is determined. For exemplary purposes, assume the given market is for the Midwest region in the United States, and the target number of promotions to have available is 100 promotions.

At 402, a target revenue to achieve from the sale of promotions in the given market is determined. For exemplary purposes, assume the target revenue to achieve from sales of promotions in the Midwest market for a given month of time is $9,500.

At 403, performance data corresponding to promotions that have previously, and/or are currently, available in the market are accessed and analyzed. For instance, the performance data may be stored in one or more of the databases 110, 112, 114, 116 or the like. Also, the analytical model 104 of the promotion offering system 102 may be tasked with performing the analysis of the performance data at 403.

Based on the analysis of the performance data at 403, at 404 one or more proposed portfolio(s) of promotions that include promotions from across a diverse mix of different promotion categories is generated. Each of the one or more proposed portfolio(s) at 404 may be generated according to the process described in 304 illustrated in FIG. 3B. From the one or more proposed portfolio(s) generated at 404, one proposed portfolio is also selected at 404 for further analysis.

Returning to flow chart 400, at 405 a determination is made whether the proposed portfolio that is selected at 404 projects revenue that at least meets the target revenue for the market. The projected revenue for the projected portfolio may have been calculated during the generation of the projected portfolio at 404. It is noted that the projected revenue is interchangeable with the reward value of the projected portfolio. If the determination at 405 finds that the proposed portfolio does not project revenue that at least meets the target revenue value from 402 ($9,500), then a determination is made at 407 as to whether another proposed portfolio is available for consideration. If another proposed portfolio is available for consideration, then at 408 a next proposed portfolio is selected and a determination as to whether the next proposed portfolio is associated with a projected revenue that at least meets the target revenue is made at 405. However, if it is determined at 407 that there are no more proposed portfolios left to consider, then at 409 the proposed portfolio that offers the optimum risk versus reward is selected. Further description on what may constitute the optimum risk versus reward value is provided below.

At 405, when a proposed portfolio is determined to be associated with a projected revenue that at least meets the target revenue, then at 406 a determination is made as to whether the proposed portfolio is associated with an acceptable level of risk. The risk value for the proposed portfolio may have been calculated during the generation of the proposed portfolio at 404.

If the level of risk associated with the proposed portfolio is determined to be acceptable (e.g., the associated risk is less than a minimum threshold) at 406, the risk versus reward values for the proposed portfolio may be recorded. For example, the risk and reward values for the proposed portfolio may be stored in a lookup table such as lookup table 4B illustrated in FIG. 4B. Each of the proposed portfolios that are included in lookup table 4B is seen to have a reward value that exceeds the $9,500 target revenue that was determined at 402. Lookup table 4B may be stored, for example, in any one of the databases 110, 112, 114, 116, wherein lookup table 4B stores the risk and reward values for proposed portfolios that at least meet the targeted revenue goal.

At 407, a determination is made as to whether there are any more projected portfolios to consider. If another proposed portfolio is available for consideration, then at 408 a next proposed portfolio is selected. The process will continue to cycle until all of the proposed portfolios generated at 404 are analyzed through 405-407.

Then at 409, the risk and reward values for the analyzed proposed portfolios are compared and the proposed portfolio that offers an optimal risk vs. reward balance will be selected.

The comparison analysis of risk and reward values at 409 may further be described with reference to the graph illustrated in FIG. 3C. The graph illustrated in FIG. 3C plots a risk value (x-axis) against a reward value (y-axis) for a plurality of proposed portfolios in accordance to the exemplary model referenced throughout the description of flow charts 300 and 400. The Efficient Frontier Zone encompasses the proposed portfolios that have been calculated to have an associated reward value that at least meets the target revenue for the market. In this case, the exemplary target revenue determined at 402 in flow chart 400 is set to be $9,500. Therefore, the Efficient Frontier Zone will cover all of the proposed portfolios that have been generated having an associated reward value (e.g., proposed portfolio revenue) that is greater than the target revenue. Then from the proposed promotions that are included within the Efficient Frontier Zone, each respective risk value may be taken into consideration.

The Efficient Frontier Zone may further be described with reference to lookup table 4B. As previously described, lookup table 4B stores the risk and reward values for proposed portfolios that have predicted revenues that exceed the target revenue from 402. Therefore the lookup table 4B will include the risk and reward values for proposed portfolios that are at least in the Efficient Frontier Zone illustrated in the graph of FIG. 3C.

The actual selection of the proposed portfolio at 409 may depend on the level of risk that is considered to be acceptable by the promotion system 100. This level of risk that the promotion system 100 is willing to take on may also vary depending on a variety of circumstances. For instance, the level of acceptable risk may be based on a predicted level of future consumer activity (e.g., promotion purchases), an amount of capital funds saved up by the promotion system 100, projected profits, and other like considerations. Under certain circumstances, a proposed portfolio having a higher reward value may be enough to overlook a correspondingly higher risk value. In other circumstances, a lower reward value along with a lower risk value may be desirable, as long as the reward value is above the target revenue value. In this way, the proposed portfolio that is selected from within the Efficient Frontier Zone may depend on the circumstances of the time.

Alternatively, instead of selecting the proposed portfolio that offers the optimum risk versus reward values at 409, in some embodiments the proposed portfolio that best matches a predicted demand for the given market may be selected. The predicted demand may have been determined according to the description provided above.

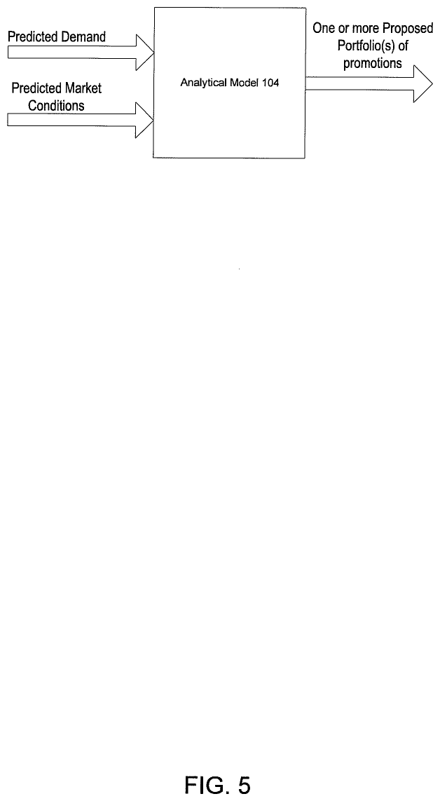

FIG. 5 illustrates a flow diagram according to an alternative embodiment of the present invention where one or more proposed portfolios are generated based on two input factors: a predicted demand for promotions in the given market, and predicted market conditions for the given market. From these two input factors, the analytical model 104 is configured to generate, and/or define, one or more proposed portfolio(s) of available promotions. Each of the one or more proposed portfolios is comprised of one or more promotions that are taken from a diverse assortment of different promotion categories. As discussed above, the analytical engine 104 may generate the predicted demand for promotions and/or predicted market conditions. One example of an analytical engine 104 is disclosed in U.S. application Ser. No. 13/411,502, incorporated by reference herein in its entirety. More specifically, U.S. application Ser. No. 13/411,502 discloses deal analytical engine 1100, which may be used to estimate demand at a future time period.

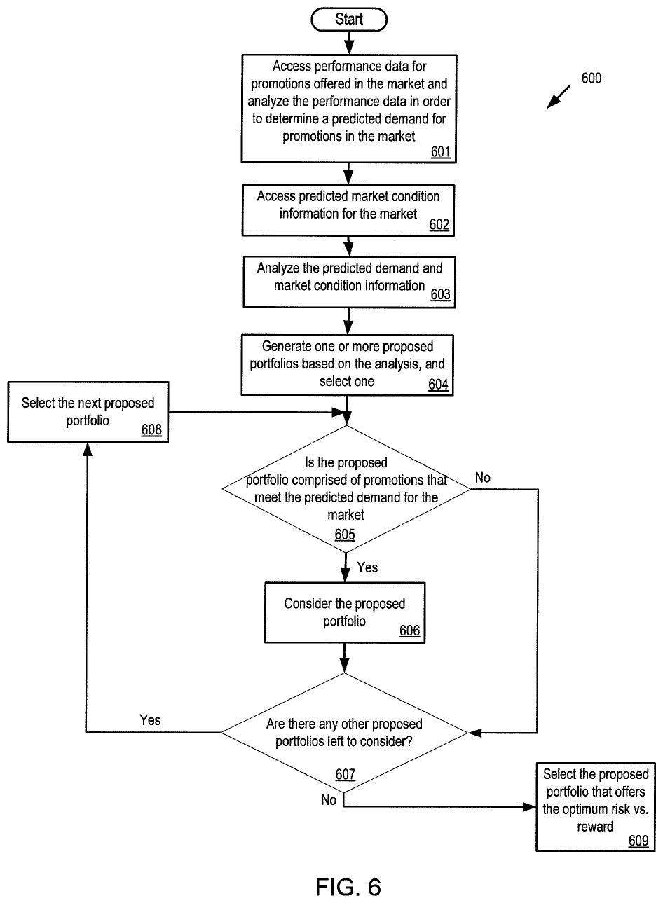

FIG. 6 illustrates a flow chart 600 describing an overview of a process for selecting a diverse portfolio of promotions to include in an inventory of promotions in a given market based on a predicted demand for promotions in the given market. According to the process described in flow chart 600, an optimum portfolio may be selected from amongst one or more proposed portfolios. Further description is provided below.

At 601, performance data for promotions offered in the given market is accessed and analyzed. From the analysis of the performance data, a predicted demand for promotions in a given market may be determined. The predicted demand value may be in terms of a number of promotions from across each promotion category, and/or sub-category, that is expected to be required to meet the demand in the given market.

At 602, predicted market conditions for the given market are accessed. The predicted market conditions may be accessed by the analytical model 104 from any one or more of the databases 110, 112, 114, 116. Alternatively, the analytical model 104 may have generated the predicted market conditions based on information that is stored in any one of the databases 110, 112, 114, 116. Examples of predicted market condition information for the given market include predicted population growth, predicted income growth, predicted inflation and predicted promotion system growth in the given market.

At 603, the predicted demand and the market condition information are analyzed.

Based on the analysis of the predicted demand and the market condition information at 603, at 604 one or more proposed portfolio(s) of promotions that include promotions from across a diverse mix of different promotion categories are generated.

At 605, a determination is made whether the proposed portfolio that is selected at 604 is comprised of promotions that meet the predicted demand for promotions in the market that was determined at 601.

If the proposed portfolio is determined to be comprised of promotions that meet the predicted demand for promotions in the market, then at 606 the proposed portfolio is recognized for later consideration.

If the proposed portfolio is determined not to be comprised of promotions that meet the predicted demand for promotions in the market, then the proposed portfolio is not recognized for later consideration.

At 607, a determination is made as to whether there are any more projected portfolios to consider. If another proposed portfolio is available for consideration, then at 608 a next proposed portfolio is selected. The process will continue to cycle until all of the proposed portfolios generated at 604 are analyzed through 605-607.

Then at 609, all of the proposed portfolios that were recognized for consideration at 606 are considered for selection at 609. From the proposed portfolios that are considered for selection at 609, the proposed portfolio that best matches the predicted demand may be selected at 609.

Once the promotion system 100 is able to select a proposed portfolio according to any one of the processes described by flow charts 300, 400, and 600 above, the promotion system 100 may undertake efforts to update and revise the current inventory of promotions that are available to match the diverse mix of promotions identified in the proposed portfolio.

If the current inventory of promotions is found to be lacking promotions from certain promotion categories in comparison to the selected proposed portfolio, the promotion system 100 may make efforts to add promotions from such promotion categories. For instance, the promotion system 100 may add promotions to the current inventory by reactivating previous promotions that may have expired. The promotion system 100 may also contact merchants, either from within the promotion system 100 or new merchants not currently in the promotion system 100, to solicit new promotions.

If the current inventory of promotions is found to have an excess of promotions from certain categories in comparison to the selected proposed portfolio, the excess promotions may be ignored (e.g., deactivated). Such excess promotions may only be ignored until a next time period when a new proposed portfolio is selected, upon which the ignored promotions may be re-activated depending on the need. In this way, excess promotions may be ignored in order to modify the inventory for the market to match the selected proposed portfolio.

In addition or alternatively, excess promotions may be further promoted or further discounted in an effort to quickly sell of the excess promotions. Further promotions may be achieved by presenting the excess promotions to consumer at a higher rate. And further discounts may be achieved by increasing the discount value of the promotion. In this way, excess promotions may be sold off in an effort to modify the inventory for the market to match the selected proposed portfolio.

By updating the inventory of promotions to follow the diverse mix of promotions identified by the selected proposed portfolio, the promotion system 100 is able to provide a more intelligent inventory of promotions that may provide a higher probability of at least meeting the target revenue and/or the previously predicted demand for the market.

In some embodiments, the promotions that are included in the selected proposed portfolio (“new portfolio”) will be a representation of a new demand prediction for the promotion system 100 in the given market. The selection of the proposed portfolio is based on a number of factors, as described above, that takes into account a risk and reward value calculated for the promotions in the selected proposed portfolio. It follows then that the promotions that are included in the new portfolio will represent a new demand for the given market, and the current promotion portfolio will likely have to be updated in order to fill the inventory of promotions in the new portfolio.

In other embodiments, a new demand for the promotion system 100 may be determined based on performance scores assigned to promotions in the promotion system 100 generally. The performance scores assigned to the promotions are a representation of a probability a consumer in the promotion system 100 will purchase the promotion. By considering all the promotions in the promotion system 100 in the aggregate, a representation for a probability that consumers in the promotion system 100 will purchase promotions may be obtained. From this probability of purchase calculation, a new demand representation may also be obtained. The promotions that are considered for this calculation of the new demand may include only those in the newly selected proposed portfolio as described above. Alternatively, promotions that are in the current promotion system 100 inventory may be considered. Alternatively, promotions that have historically been offered in the promotion system 100 may be considered.

Promotions are ultimately offered by merchants, and merchants are contacted about their promotion offerings by representatives associated with the administrators of the promotion system 100. Therefore, for those promotions in the new portfolio that are not presently included in the promotion system's current portfolio of available promotions, these promotions may be obtained via a representative contacting a merchant and requesting the merchant offer the promotion to consumers in the promotion system 100. In an effort to obtain the needed promotion(s) to update the current promotion portfolio to match the new portfolio, the representative may contact one or more merchants (e.g., merchants 118 and 120) that are currently a part of the promotion system 100. In addition or alternatively, the representative may contact one or more new merchants that are not currently involved in the promotion system 100. New merchants may be signed up by the representative to be a part of the promotion system if the new merchant agrees to offer a promotion to consumers in the promotion system 100. In addition or alternatively, the representative may contact a merchant that previously offered a promotion within the promotion system 100, but who has not been active for a period of time. The representative may try to re-activate such a dormant merchant by convincing the dormant merchant to again offer a promotion to consumers in the promotion system 100. In addition or alternatively, the needed promotion(s) may be obtained via one or more repository of deals as described above.

More than one merchant may be capable of offering a promotion that is needed in order to match the inventory of promotions found in the new portfolio. Although contacting all possible merchants that are capable of offering a needed promotion is possible, it may not be the most efficient solution for obtaining the needed promotion. Therefore, there is a need for a way to prioritize merchants (e.g., develop an order for contacting merchants). By prioritizing merchants, representatives may have a guideline for an order of contacting merchants. In some embodiments, merchants may be prioritized by assigning a merchant a merchant score, such that merchants will be contacted according to the merchant's score.

One factor that may be considered when prioritizing merchants is a probability the representative will close the merchant (e.g., probability the representative will convince the merchant to offer the needed promotion). The probability of closing the merchant may be based on a number of factors such as, for example, quality of the lead that led to contacting the merchant, merchant attributes, stage of the closing during the negotiation period between the representative and the merchant, interfacing time (e.g., talking or meeting time) between the representative and the merchant, past and/or current history of the merchant offering promotions in the promotion system 100, and other similar factors.

The probability of closing the merchant may also be based on whether the representative is asking the merchant to revive a previous promotion offering, or asking the merchant to offer a completely new promotion. For instance, the probability of closing a deal with the merchant to revive a previously offered promotion may be considered to be easier than closing a deal with the merchant to offer a completely new promotion.

Another factor that may be considered when prioritizing merchants is a merchant's value. The merchant value may be a representation of expected revenue from including the merchant's promotion offering into the new portfolio for presentation in the promotion system 100. In other words, the merchant value may represent revenue from consumer's purchasing the merchant's promotion offering. In addition or alternatively, the merchant value may represent a number of consumers that have purchased from the merchant, or a number of consumers who are expected to purchase from the merchant.

The merchant value may be based on a number of factors such as, for example, location of the merchant, services offered by the merchant, sales associated with the merchant, and other similar factors. The merchant's value may also be based on the type of promotions the merchant can offer versus promotions that are needed by the promotion system 100 in order to match the anticipated demand. If the merchant offers promotions that are not needed in order to meet the new portfolio, the merchant's value may go down. If the merchant offers promotions that are needed to match the new portfolio, but there is an abundant supply of other merchants that offer equivalent promotions or if there is an abundant supply of equivalent promotions overall, the merchant's value may go down. If, however, the merchant can offer a promotion that is needed in order to meet the anticipated demand shown in the new portfolio, the merchant's value may go up. And further, if the merchant can offer a promotion that is needed, and there is a dearth in supply of the promotion, the merchant's value may go up.

The merchant's value may also be based on the merchant's level of involvement in the promotion system 100 over a period of time. A greater level of involvement may result in a greater merchant value, while a lower level of involvement may result in a lower merchant value.

Now a merchant's priority may be determined based on at least all the factors described above. The merchant's priority may correspond to the merchant's rank compared to other merchants in the promotion system 100. In some embodiments, merchants may be prioritized uniquely for each representative based on attributes of the representative. Further description is provided below.

As mentioned above, representatives of the administrator of the promotion system 100 are responsible for contacting merchants in order to convince the merchants to offer promotions into the promotion system 100. Although ideal, a representative is not likely to convert each call to a merchant into a closing of a deal ensuring the merchant will offer a promotion into the promotion system 100. Therefore, each representative may be assigned a representative performance score that tracks a number of merchant deal closings against a number of merchants contacted by the representative. The representative's performance score may further be specified according to the promotions that are offered by the contacted merchants. For instance, the representative's performance score may be generated to account for the representative's success rate for converting on merchant's when trying to obtain promotions from across different promotion categories, sub-categories, DTs and other like promotion attributes. So the representative may have a performance score for converting merchants when trying to obtain restaurant category promotions from merchants, and a separate performance score for converting merchants when trying to obtain travel category promotions from merchants.

Each representative may be assigned a book of merchants from which to call in order to try and convince a merchant to offer a promotion into the promotion system 100. When a representative is first starting out, the representative may be assigned, for example, a starter book of merchants. The starter book of merchants may be comprised of a known starting composition of merchants. For example, a starter book of merchants may be comprised of 50 existing merchants in the promotion system 100, and 300 new merchants.

In addition, the representative may be required to maintain a minimal standard composition of merchants in the representative's book of merchants. For example, the book of merchants may be required to include at least a set number of merchants (e.g., 350 merchants minimum). In addition or alternatively, the book of merchants may be required to include at least a set number of new merchants (e.g., 20% new merchants) that either do not have current involvement in the promotion system 100 or are merchants that are currently dormant. In addition or alternatively, the book of merchants may be required to maintain a predetermined ratio of merchants that offer promotions from a predetermined set of promotions. For example, the book of merchants may be required to include 20% merchants that offer food and drink category promotions, 10% merchants that offer health and beauty category promotions, and 10% merchants that offer leisure category promotions.

As the representative is able to contact a merchant in the representative's book of merchants and convince the merchant to offer a promotion in the promotion system 100, the closed promotion is included into the current inventory of promotions for the promotion system 100. However new merchants that are not currently in the book of merchants may be introduced to the promotion system 100. The new merchants may be introduced via a new externally introduced warm lead, a new internally researched lead or an internal sweep of dormant merchants that have previously offered promotions but have remained inactive for a set period of time.

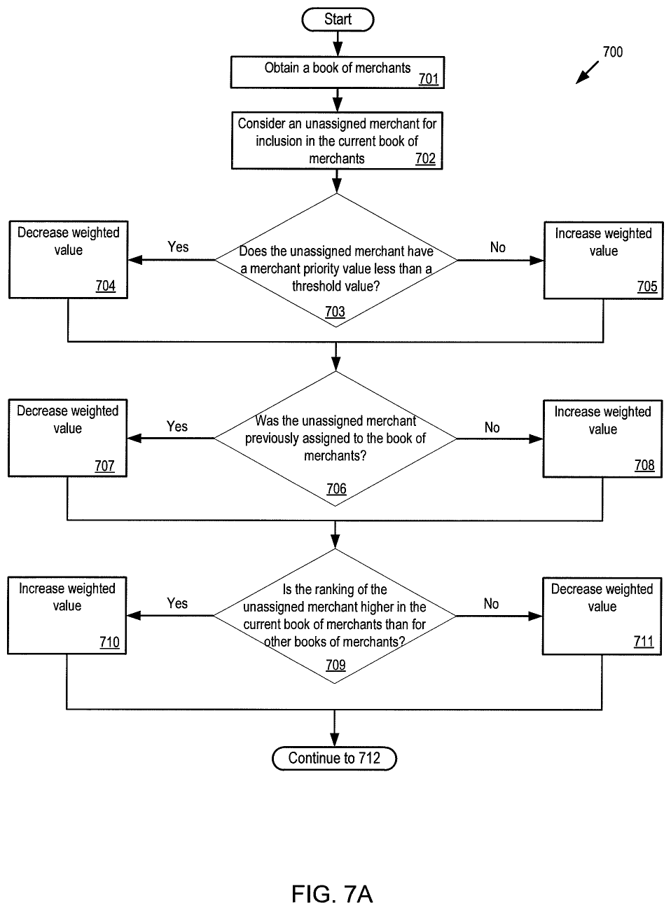

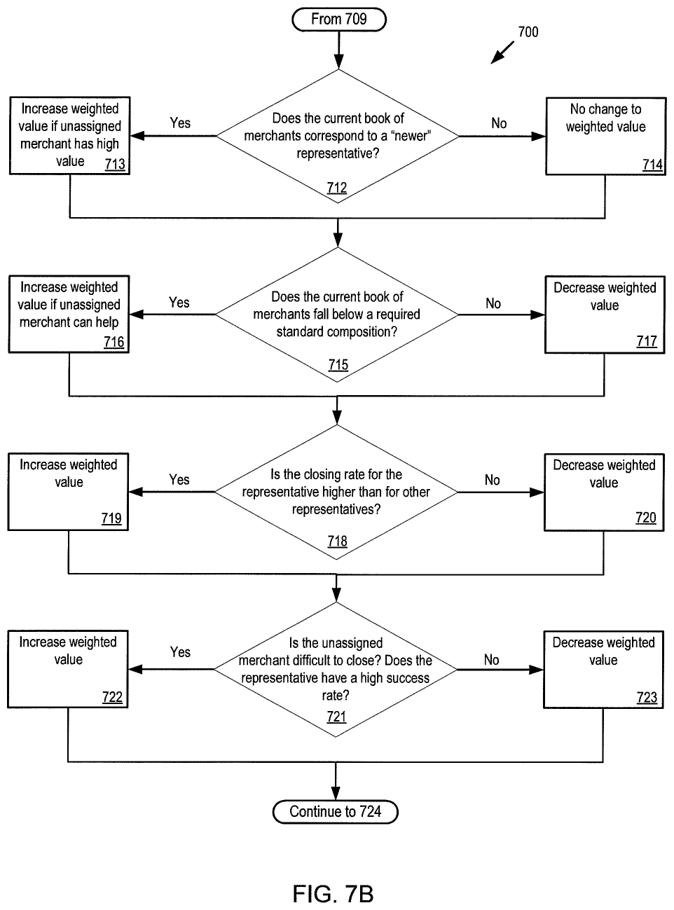

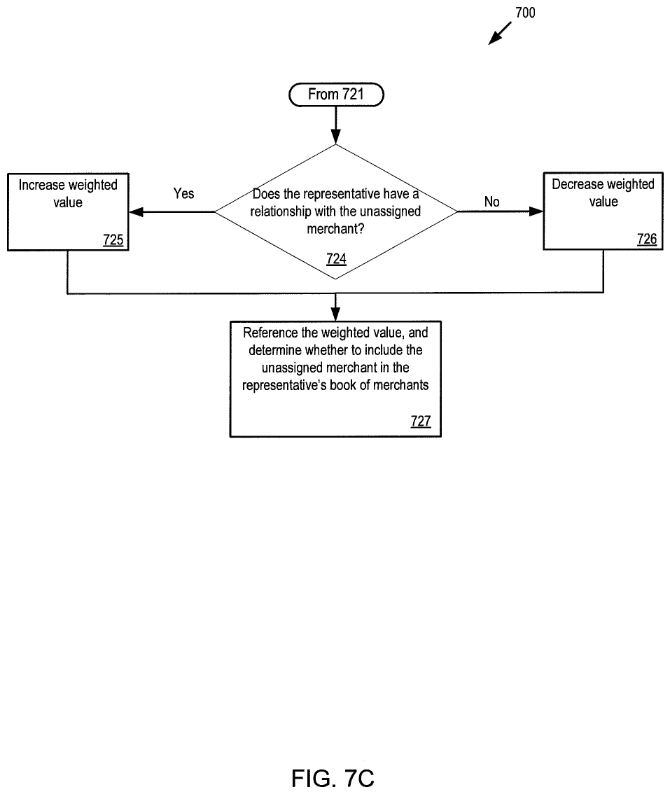

It is an objective of the present invention to promote fairness and evenness when allocating new merchants to the plurality of representatives that are associated with the promotion system 100. In an effort to promote fairness in allocating new merchants to representatives, the present invention provides a method and system for allocating new merchants across a plurality of representatives associated with the administrator of the promotion system 100, as illustrated by the flow chart 700 described in FIGS. 7A through 7C.

FIGS. 7A through 7C illustrate a flow chart 700 describing a process for allocating an unassigned merchant to a representative's book of merchants according to the present invention. The process described by flow chart 700 involves going through a plurality of individual determinations in order to provide the book of merchants, or alternatively the corresponding representative, with a weighted value. Each individual determination will be used to impact the weighted value, where the weighted value will be referenced when making the final determination of whether to include the unassigned merchant in the representative's book of merchants. It is assumed that other representatives in the promotion system 100 will similarly have their respective book of merchants analyzed according to the process described by flow chart 700 in order to determine whether the unassigned merchant shall be included in their respective book of merchants.

It is noted that all of the individual determinations illustrated in flow chart 700 are provided for exemplary purposes only. The present invention contemplates a process for allocating an unassigned merchant to a representative's book of merchants that includes any combination of one or more of the individual determinations described in flow chart 700. Further description is provided below.

At 701 a representative is presented with a book of merchants. For example, the book of merchants may be the starter book of merchants assigned to a new representative, as described above.

At 702, an unassigned merchant may be considered for inclusion in the representative's book of merchants. The unassigned merchant may be a new merchant as described above. The unassigned merchant may also be a merchant that has previously offered promotions in the promotion system 100 in the past, but has become dormant, as described above. The unassigned merchant may have been brought into consideration based on a lead, either internally or externally, or based on a sweep of dormant merchants as described above.

At 703, a first determination is made as to whether the unassigned merchant has a corresponding merchant priority value that is less than a threshold value. The merchant priority value may be, for example, a ranking of the merchant against other merchants as described above. For instance, the unassigned merchant's priority value may be compared against the merchant values for the merchant's already included in the representative's book of merchants. Then, if the unassigned merchant's priority value indicates the unassigned merchant would be ranked amongst the rest of the merchants in the book of merchants at a level that is lower than a threshold value, then the weighted value is decreased at 704. The decreased weighted value will decrease the probability of the unassigned merchant being included in the representative's book of merchants. If the unassigned merchant's priority value indicates the unassigned merchant would be ranked amongst the rest of the merchants in the book of merchants at a level that is higher than a threshold value, then the weighted value is increased at 705. The increased weighted value will increase the probability of the unassigned merchant being included in the representative's book of merchants.

In some embodiments, if the unassigned merchant is found to be ranked lower than a threshold value, the unassigned merchant may be automatically removed from consideration for the representative's book of merchants. For example, the threshold value may indicate that the unassigned merchant must be ranked, according to its priority value (e.g., ranking value or merchant value), no lower than in the top 100 merchants. Therefore, if the unassigned merchant were to be ranked lower than the top 100 merchants when compared against the merchants already included in the book of merchants, the unassigned merchant may be excluded from the book of merchants or alternatively the weighted value may be decreased in order to decrease the probability of the unassigned merchant being included in the representative's book of merchants.

At 706, a second determination is made as to whether the unassigned merchant was previously assigned to the representative, and more specifically whether the unassigned merchant was previously assigned to the representative's book of merchants. If the unassigned merchant is found to have been previously assigned to the representative, then the weighted value is decreased at 707. The weighted value is decreased because this indicates the representative was previously assigned the responsibility to handle and care for the unassigned merchant, but neglected his/her duty as evidenced by the merchant becoming unassigned. If the unassigned merchant is not found to have been previously assigned to the representative, then the weighted value is increased at 708. Alternatively, the weighted value may remain the same when the unassigned merchant is found not to have previously been assigned to the representative.

At 709, a third determination is made as to whether the unassigned merchant would be ranked higher in the representative's book of merchants compared to the unassigned merchant's ranking in another representative's book of merchants. The ranking may be based on the merchant's priority value or merchant value as described above. If the unassigned merchant's ranking for the representative's book of merchants is higher than for a corresponding ranking of the unassigned merchant in the other representative's book of merchants, then the weighted value is increased at 710. Representatives may contact merchants in their book of merchants according to the merchant ranking. Therefore, the representative will have a greater likelihood of contacting merchants that are ranked higher. This is important because higher ranked merchants may have higher merchant values, which in turn may return a greater revenue amount when the promotion offered by the merchant is purchased. In some embodiments, the amount of increase of the weighted value may be directly related to the number of other books of merchants where the unassigned merchant will be ranked lower (e.g., the unassigned merchant is ranked higher in the current book of merchants over how many other books of merchants). So the greatest increase in the weighted value may occur when the unassigned merchant is ranked higher in the current book of merchants over all the other books of merchants.

If however, the unassigned merchant is not ranked higher in the current representative's book of merchants when compared to the other books of merchants, the weighted value may be decreased at 711, or alternatively remain the same. In some embodiments, the amount of decrease of the weighted value may be directly related to the number of other books of merchants where the unassigned merchant will be ranked higher. So the greatest decrease in the weighted value may occur when the unassigned merchant is ranked higher in all the other books of merchants. In some embodiments, if the unassigned merchant is ranked higher in all the other books of merchants, the unassigned merchant may automatically be excluded from the current representative's book of merchants.

Continuing to FIG. 7B, at 712 a fourth determination is made as to whether the current representative of the book of merchants is a “newer” representative. The representative may be considered to be “newer” if the representative has been working for the administrator of the promotion system 100 for less than a set period of time, for example less than 3 months. The representative may also be considered to be “newer” if the representative has been working for a shorter period of time than other representative. So if the representative can be considered to be “newer” at 712, the weighted value may be increased at 713 if the unassigned merchant has a high probability to close value. This is because it is desirable to give unassigned merchants with a high probability of closing (e.g., easier to close) to “newer” representatives. In some embodiments the representative may be considered “newer” if the representative has been working for the shortest amount of time compared to other representatives. In some embodiments the representative may be considered to be “newer” if the representative has been working for a shorter amount of time over a set number of other representatives.

If the representative cannot be considered to be “newer” at 712, then there may not be a change to the weighted value at 714. Alternatively, the weighted value may be decreased at 714, or alternatively remain the same.

At 715, a fifth determination is made as to whether the representative's book of merchants contains a required standard composition of merchants. The standard composition of merchants may require a set overall number of merchants be included in the book of merchants. The standard composition may in addition, or alternatively, require a set ratio of merchants that offer promotions from across different promotion categories, sub-categories, DTs or other definable promotion attribute as described above. If the representative's current book of merchants falls below the required standard composition at 715, then the weighted value may be increased if the unassigned merchant can help the book of merchants get closer to the standard composition. If the inclusion of the unassigned merchant into the representative's book of merchants does not help the book of merchants get closer to the standard composition, the weighted value may not increase at 716.

If the representative's book of merchants does not fall below the standard composition at 715, the weighted value may be decreased at 717. Alternatively, the weighted value may not change at 717 if the representative's book of merchants does not fall below the standard composition.

At 718, a sixth determination is made as to whether the representative has a rate of closing that is higher than the other representatives in the promotion system 100. The closing rate may refer to a rate at which the representative is able to contact a merchant and convince the merchant to offer a promotion into the promotion system 100. If the representative's closing rate is higher than all other representatives, the weighted value may be increased at 719. In some embodiments, the amount of increase may be related to a number of other representatives that the current representative has a higher closing rate over.

If at 718 the representative is found not to have a higher closing rate over other representatives, the weighted value may be decreased at 720, or alternatively remain the same. In some embodiments, the determination at 718 is not applied to representatives that may be considered to be “newer” as described above.

At 721, a seventh determination is made as to whether the unassigned merchant is difficult to close and whether the representative has a high success rate at closing deals with merchants. A merchant may be defined as being difficult to close if the rate at which representatives contact the merchant and the merchant declines to offer a promotion into the promotion system 100 falls below a threshold number. A representative may be defined as being successful in closing deals with merchants if the rate at which the representative contacts merchants and closes deals with merchants for the merchants to offer promotions in the promotion system 100 is over a threshold number. A successful closing rate for a representative may further be defined according to a success rate for a particular merchant offering promotions in particular promotion categories, sub-categories, DTs or other definable promotion attribute. For instance, the representative may have a 30% success rate for closing merchants offering restaurant promotions. The same representative may also have a 10% success rate for closing merchants offering travel promotions. In this scenario, the representative has a greater success rate for one promotion category over another.

If at 721 the unassigned merchant is found to be difficult to close, and the representative is found to have a high success rate, at 722 the weighted value may be increased. In some embodiments, a high success rate may be a merchant closing rate that is higher than a certain percentage (e.g., merchant closing rate of greater than 30%). In some embodiments only a certain top number of representatives may be considered for the unassigned merchant. For instance, if the merchant is offering a restaurant promotion, then only representatives that have a success rate in the top 30% of representatives for the restaurant category may be considered for being assigned the unassigned merchant.

If the representative does not have a high success rate, at 723 the weighted value may be decreased, or alternatively remain the same.

Continuing to FIG. 7C, at 724 an eighth determination is made as to whether the representative has a prior relationship with the unassigned merchant. For instance, the representative may be an acquaintance of the unassigned merchant. If this is true, then at 725 the weighted value is increased. If the representative does not have a prior relationship with the unassigned merchant, the weighted value may be decreased, or alternatively remain the same at 726.

At the end of processing through one or more of the individual determinations described above for flow chart 700, the weighted value may be referenced to determine whether to include the unassigned merchant in the representative's book of merchants. See 727. In some embodiments the unassigned merchant may be included in the representative's book of merchants if the weighted value is greater than a threshold value.

According to the present invention, there may instances where merchants are removed, or reallocated, from the representative's book of merchants. For instance, a merchant may be removed from the representative's book of business when the representative is no longer associated with the promotion system (e.g., no longer works for the administrator of the promotion system).

A merchant may also be removed from the representative's book of business when the representative has not contacted the merchant within a set period of time. For example, the merchant may also be removed from the representative's book of business when the representative has not contacted the merchant within 2 days of the merchant being assigned to the representative's book of merchants.

A merchant may also be removed from the representative's book of business when the representative has not been active in contacting merchants in the representative's book of merchants for a set period of time from being assigned the merchant. For instance, the merchant may be removed from the representative's book of business if it is found that the representative has been inactive in contacting merchants from the representative's book of merchants for 10 days since the time the merchant was assigned to the representative.

The merchant may also be removed from the representative's book of business if it is found that the representative has been inactive in contacting merchants from the representative's book of merchants for a set period of time overall. For instance, the merchant may be removed from the representative's book of business if it is found that the representative has been inactive in contacting merchants from the representative's book of merchants for 35 days.

The merchant may also be removed from the representative's book of business if it is found that the representative has not been able to successfully close on a merchant for a set period of time overall. For instance, the merchant may be removed from the representative's book of business if it is found that the representative has not been able to successfully close on a merchant for 90 days.

A merchant that is removed from may be considered an un-assigned merchant and be put through the process described by flow chart 700 above.

It should be noted that all mention of a merchant included in a book of merchants may refer to an account corresponding to the merchant. The account may contain information describing the merchant's attributes and promotions that are, or have been, offered into the promotion system 100 by the merchant.

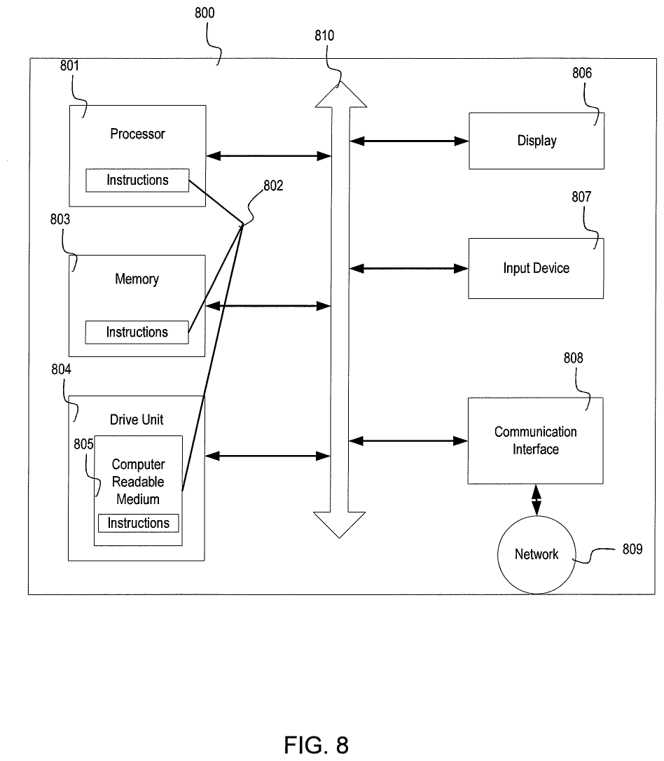

FIG. 8 illustrates a general computer system 800, programmable to be a specific computer system 800, which can represent any server, computer or component, such as consumer 1 (124), consumer N (126), merchant 1 (118), merchant M (120), and promotion offering system 102. The computer system 800 may include an ordered listing of a set of instructions 802 that may be executed to cause the computer system 800 to perform any one or more of the methods or computer-based functions disclosed herein. The computer system 800 can operate as a stand-alone device or can be connected, e.g., using the network 122, to other computer systems or peripheral devices.

In a networked deployment, the computer system 800 can operate in the capacity of a server or as a client-user computer in a server-client user network environment, or as a peer computer system in a peer-to-peer (or distributed) network environment. The computer system 800 may also be implemented as or incorporated into various devices, such as a personal computer or a mobile computing device capable of executing a set of instructions 802 that specify actions to be taken by that machine, including and not limited to, accessing the Internet or Web through any form of browser. Further, each of the systems described can include any collection of sub-systems that individually or jointly execute a set, or multiple sets, of instructions to perform one or more computer functions.

The computer system 800 can include a memory 803 on a bus 810 for communicating information. Code operable to cause the computer system to perform any of the acts or operations described herein can be stored in the memory 803. The memory 803 may be a random-access memory, read-only memory, programmable memory, hard disk drive or any other type of volatile or non-volatile memory or storage device.

The computer system 800 can include a processor 801, such as a central processing unit (CPU) and/or a graphics processing unit (GPU). The processor 801 may include one or more general processors, digital signal processors, application specific integrated circuits, field programmable gate arrays, digital circuits, optical circuits, analog circuits, combinations thereof, or other now known or later-developed devices for analyzing and processing data. The processor 801 may implement the set of instructions 802 or other software program, such as manually programmed or computer-generated code for implementing logical functions. The logical function or any system element described can, among other functions, process and convert an analog data source such as an analog electrical, audio, or video signal, or a combination thereof, to a digital data source for audio-visual purposes or other digital processing purposes such as for compatibility for computer processing.

The computer system 800 can also include a disk or optical drive unit 804. The disk drive unit 804 may include a computer-readable medium 805 in which one or more sets of instructions 802, e.g., software, may be embedded. Further, the instructions 802 may perform one or more of the operations as described herein. The instructions 802 may reside completely, or at least partially, within the memory 803 or within the processor 801 during execution by the computer system 800. Accordingly, the databases 110, 112, 114, or 116 may be stored in the memory 803 or the disk unit 804.

The memory 803 and the processor 801 also may include computer-readable media as discussed above. A “computer-readable medium,” “computer-readable storage medium,” “machine readable medium,” “propagated-signal medium,” or “signal-bearing medium” may include any device that has, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium.

Additionally, the computer system 800 may include an input device 807, such as a keyboard or mouse, configured for a user to interact with any of the components of system 800. It may further include a display 806, such as a liquid crystal display (LCD), a cathode ray tube (CRT), or any other display suitable for conveying information. The display 806 may act as an interface for the user to see the functioning of the processor 801, or specifically as an interface with the software stored in the memory 803 or the drive unit 804.

The computer system 800 may include a communication interface 808 that enables communications via the communications network 122, shown in FIG. 8 as network 809. The network 122 may include wired networks, wireless networks, or combinations thereof. The communication interface 808 network may enable communications via any number of communication standards, such as 802.11, 802.17, 802.20, WiMax, 802.15.4, cellular telephone standards, or other communication standards, as discussed above. Simply because one of these standards is listed does not mean any one is preferred.

Further, the promotion offering system 102, as depicted in FIG. 1 may comprise one computer system or multiple computer systems. Further, the flow diagrams illustrated in the Figures may use computer readable instructions that are executed by one or more processors in order to implement the functionality disclosed.

The present disclosure contemplates a computer-readable medium that includes instructions or receives and executes instructions responsive to a propagated signal, so that a device connected to a network can communicate voice, video, audio, images or any other data over the network. Further, the instructions can be transmitted or received over the network via a communication interface. The communication interface can be a part of the processor or can be a separate component. The communication interface can be created in software or can be a physical connection in hardware. The communication interface can be configured to connect with a network, external media, the display, or any other components in system, or combinations thereof. The connection with the network can be a physical connection, such as a wired Ethernet connection or can be established wirelessly as discussed below. In the case of a service provider server, the service provider server can communicate with users through the communication interface.

The computer-readable medium can be a single medium, or the computer-readable medium can be a single medium or multiple media, such as a centralized or distributed database, or associated caches and servers that store one or more sets of instructions. The term “computer-readable medium” can also include any medium that can be capable of storing, encoding or carrying a set of instructions for execution by a processor or that can cause a computer system to perform any one or more of the methods or operations disclosed herein.

The computer-readable medium can include a solid-state memory such as a memory card or other package that houses one or more non-volatile read-only memories. The computer-readable medium also may be a random access memory or other volatile re-writable memory. Additionally, the computer-readable medium may include a magneto-optical or optical medium, such as a disk or tapes or other storage device to capture carrier wave signals such as a signal communicated over a transmission medium. A digital file attachment to an email or other self-contained information archive or set of archives may be considered a distribution medium that may be a tangible storage medium. The computer-readable medium may comprise a tangible storage medium. In some embodiments, the computer-readable medium may comprise a non-transitory medium. Accordingly, the disclosure may be considered to include any one or more of a computer-readable medium or a distribution medium and other equivalents and successor media, in which data or instructions can be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or in addition, virtual computer system processing may be constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments can be apparent to those of skill in the art upon reviewing the disclosure. Other embodiments can be utilized and derived from the disclosure, such that structural and logical substitutions and changes can be made without departing from the scope of the disclosure. Additionally, the illustrations are merely representational and cannot be drawn to scale. Certain proportions within the illustrations may be exaggerated, while other proportions may be minimized. Accordingly, the disclosure and the figures are to be regarded as illustrative rather than restrictive.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

What is claimed is:

1. A method comprising:
determining a set target number of promotions to remain available in an inventory of promotions in a geographic area, wherein the determination of the set target number of promotions to remain available in the inventory of promotions in the geographic area comprises: determining an expected demand for promotions based on a size of the geographic area or a population of the geographic area;
determining a target revenue over a predefined period of time for the geographic area;
utilizing an analytical model to intelligently generate a proposed promotion portfolio of available promotions by:
performing an iterative process in which a determination is made as to whether the proposed promotion portfolio that is generated projects a predicted revenue that at least meets the target revenue over the predefined period of time for the geographic area,
wherein the iterative process comprises:
identifying each of a plurality of categories of promotions for inclusion in the portfolio of available promotions;
for each of the plurality of categories of promotions,
analyzing historical performance data to:
calculate an average promotion value (APV) for each of the plurality of categories; and
access a predefined set of weighting values for the plurality of categories,
wherein the weighting values for each of plurality of categories of the proposed promotion portfolio sums to 100%;
determine a proposed promotion portfolio return value in accordance with the weighing values for each of the plurality of categories and the APV of each of the plurality of categories;
in an instance in which the determined proposed promotion portfolio value fails to meet the target revenue over the predefined period of time for the geographic area, repeating the iterative process and altering the weighting values; and
in an instance in which the determined proposed promotion portfolio value at least meets the target revenue over the predefined period of time for the geographic area, ending iterative process; and
generating the inventory of promotions in accordance with the proposed promotion portfolio.

2. The method of claim 1, further comprising:
in an instance in which a current inventory of promotions lacks promotions from a particular promotion category in comparison to the proposed promotion portfolio, reactivating one or more expired promotions within the particular category.

3. The method of claim 1, further comprising:
determining, for each category, a standard deviation of promotion values based on historical performance of promotions in a particular category.

4. The method of claim 3, further comprising:
summing each of the standard deviations; and
in an instance in which the sum of the standard deviations of promotion values exceeds a predefined threshold, repeating the iterative process and altering the weighting values.

5. The method of claim 1, wherein the iterative process further comprises:
identifying each of a plurality of price ranges of promotions for inclusion in the portfolio of available promotions;
for each of the plurality of price ranges of promotions,
analyzing historical performance data to:
calculate an average promotion value (APV) for each of the plurality of price ranges; and
access a predefined set of weighting values for the plurality of price ranges,
wherein the weighting values for each of plurality of price ranges of the proposed promotion portfolio sums to 100%;
determine a proposed promotion portfolio return value in accordance with the weighing values for each of the plurality of price ranges and the APV of each of the plurality of price ranges;
in an instance in which the determined proposed promotion portfolio value fails to meet the target revenue over the predefined period of time for the geographic area, repeat the iterative process and alter the weighting values; and
in an instance in which the determined proposed promotion portfolio value at least meets the target revenue over the predefined period of time for the geographic area, end iterative process.

6. The method of claim 1, further comprising:
in an instance in which a current inventory of promotions lacks promotions from a particular price range in comparison to the proposed promotion portfolio, reactivating one or more expired promotions within the particular price range.

7. The method of claim 1, further comprising:
determining, for each price range, a standard deviation of promotion values based on historical performance of promotions in a particular price range; and
in an instance in which a sum of the standard deviations of promotion values exceeds a predefined threshold, repeating the iterative process and altering the weighting values.

8. An apparatus comprising at least one processor and at least one memory including computer program code, the at least one memory and the computer program code configured to, with the processor, cause the apparatus to at least:
determine a set target number of promotions to remain available in an inventory of promotions in a geographic area, wherein the determination of the set target number of promotions to remain available in the inventory of promotions in the geographic area comprises: determining an expected demand for promotions based on a size of the geographic area or a population of the geographic area;
determine a target revenue over a predefined period of time for the geographic area;
utilize an analytical model to intelligently generate a proposed promotion portfolio of available promotions by:
perform an iterative process in which a determination is made as to whether the proposed promotion portfolio that is generated projects a predicted revenue that at least meets the target revenue over the predefined period of time for the geographic area,
wherein the iterative process comprises:
identify each of a plurality of categories of promotions for inclusion in the portfolio of available promotions;
for each of the plurality of categories of promotions,
analyze historical performance data to:
calculate an average promotion value (APV) for each of the plurality of categories; and
access a predefined set of weighting values for the plurality of categories,
wherein the weighting values for each of plurality of categories of the proposed promotion portfolio sums to 100%;
determine a proposed promotion portfolio return value in accordance with the weighing values for each of the plurality of categories and the APV of each of the plurality of categories;
in an instance in which the determined proposed promotion portfolio value fails to meet the target revenue over the predefined period of time for the geographic area, repeat the iterative process and alter the weighting values; and
in an instance in which the determined proposed promotion portfolio value at least meets the target revenue over the predefined period of time for the geographic area, end iterative process; and
generate the inventory of promotions in accordance with the proposed promotion portfolio.

9. An apparatus according to claim 8, wherein the at least one memory and the computer program code are further configured to, with the processor, cause the apparatus to:
in an instance in which a current inventory of promotions lacks promotions from a particular promotion category in comparison to the proposed promotion portfolio, reactivate one or more expired promotions within the particular category.

10. An apparatus according to claim 8, wherein the at least one memory and the computer program code are further configured to, with the processor, cause the apparatus to:
determine, for each category, a standard deviation of promotion values based on historical performance of promotions in a particular category.

11. An apparatus according to claim 8, wherein the at least one memory and the computer program code are further configured to, with the processor, cause the apparatus to:
sum each of the standard deviations; and
in an instance in which the sum of the standard deviations of promotion values exceeds a predefined threshold, repeat the iterative process and alter the weighting values.

12. An apparatus according to claim 8, wherein the iterative process further comprises:
identify each of a plurality of price ranges of promotions for inclusion in the portfolio of available promotions;
for each of the plurality of price ranges of promotions,
analyze historical performance data to:
calculate an average promotion value (APV) for each of the plurality of price ranges; and
access a predefined set of weighting values for the plurality of price ranges,
wherein the weighting values for each of plurality of price ranges of the proposed promotion portfolio sums to 100%;
determine a proposed promotion portfolio return value in accordance with the weighing values for each of the plurality of price ranges and the APV of each of the plurality of price ranges;
in an instance in which the determined proposed promotion portfolio value fails to meet the target revenue over the predefined period of time for the geographic area, repeat the iterative process and alter the weighting values; and
in an instance in which the determined proposed promotion portfolio value at least meets the target revenue over the predefined period of time for the geographic area, end iterative process.

13. An apparatus according to claim 8, wherein the at least one memory and the computer program code are further configured to, with the processor, cause the apparatus to:
in an instance in which a current inventory of promotions lacks promotions from a particular price range in comparison to the proposed promotion portfolio, reactivate one or more expired promotions within the particular price range.

14. An apparatus according to claim 8, wherein the at least one memory and the computer program code are further configured to, with the processor, cause the apparatus to:
determine, for each price range, a standard deviation of promotion values based on historical performance of promotions in a particular price range; and
in an instance in which a sum of the standard deviations of promotion values exceeds a predefined threshold, repeat the iterative process and alter the weighting values.

15. A computer program product comprising at least one non-transitory computer-readable storage medium having computer-executable program code instructions stored therein, the computer-executable program code instructions comprising program code instructions to:
determine a set target number of promotions to remain available in an inventory of promotions in a geographic area, wherein the determination of the set target number of promotions to remain available in the inventory of promotions in the geographic area comprises: determining an expected demand for promotions based on a size of the geographic area or a population of the geographic area;
determine a target revenue over a predefined period of time for the geographic area;
utilize an analytical model to intelligently generate a proposed promotion portfolio of available promotions by:
perform an iterative process in which a determination is made as to whether the proposed promotion portfolio that is generated projects a predicted revenue that at least meets the target revenue over the predefined period of time for the geographic area,
wherein the iterative process comprises:
identify each of a plurality of categories of promotions for inclusion in the portfolio of available promotions;
for each of the plurality of categories of promotions,
analyze historical performance data to:
calculate an average promotion value (APV) for each of the plurality of categories; and
access a predefined set of weighting values for the plurality of categories,
wherein the weighting values for each of plurality of categories of the proposed promotion portfolio sums to 100%;
determine a proposed promotion portfolio return value in accordance with the weighing values for each of the plurality of categories and the APV of each of the plurality of categories;
in an instance in which the determined proposed promotion portfolio value fails to meet the target revenue over the predefined period of time for the geographic area, repeat the iterative process and alter the weighting values; and
in an instance in which the determined proposed promotion portfolio value at least meets the target revenue over the predefined period of time for the geographic area, end iterative process; and
generate the inventory of promotions in accordance with the proposed promotion portfolio.

16. The computer program product according to claim 15, wherein the computer-executable program code instructions further comprise program code instructions to:
in an instance in which a current inventory of promotions lacks promotions from a particular promotion category in comparison to the proposed promotion portfolio, reactivate one or more expired promotions within the particular category.

17. The computer program product according to claim 15, wherein the computer-executable program code instructions further comprise program code instructions to:
determine, for each category, a standard deviation of promotion values based on historical performance of promotions in a particular category.

18. The computer program product according to claim 17, wherein the computer-executable program code instructions further comprise program code instructions to:
sum each of the standard deviations; and
in an instance in which the sum of the standard deviations of promotion values exceeds a predefined threshold, repeat the iterative process and altering the weighting values.

19. The computer program product according to claim 15, wherein the iterative process further comprises program code instructions to:
identify each of a plurality of price ranges of promotions for inclusion in the portfolio of available promotions;
for each of the plurality of price ranges of promotions,
analyze historical performance data to:
calculate an average promotion value (APV) for each of the plurality of price ranges; and
access a predefined set of weighting values for the plurality of price ranges,
wherein the weighting values for each of plurality of price ranges of the proposed promotion portfolio sums to 100%;
determine a proposed promotion portfolio return value in accordance with the weighing values for each of the plurality of price ranges and the APV of each of the plurality of price ranges;
in an instance in which the determined proposed promotion portfolio value fails to meet the target revenue over the predefined period of time for the geographic area, repeat the iterative process and alter the weighting values; and
in an instance in which the determined proposed promotion portfolio value at least meets the target revenue over the predefined period of time for the geographic area, end iterative process

20. The computer program product according to claim 15, wherein the computer-executable program code instructions further comprise program code instructions to:
in an instance in which a current inventory of promotions lacks promotions from a particular price range in comparison to the proposed promotion portfolio, reactivate one or more expired promotions within the particular price range.

21. The computer program product according to claim 15, wherein the computer-executable program code instructions further comprise program code instructions to:
determine, for each price range, a standard deviation of promotion values based on historical performance of promotions in a particular price range; and
in an instance in which a sum of the standard deviations of promotion values exceeds a predefined threshold, repeat the iterative process and altering the weighting values.
